(19) United States
(12) Patent Application Publication
(10) Pub. No.: US 2024/0063578 A1
(43) Pub. Date: Feb. 22, 2024

(54) NON-DIRECTIONAL DOCKING ELECTRICAL CONNECTOR AND BASE THEREOF

(71) Applicant: ENERGY FULL ELECTRONICS CO., LTD., New Taipei City (TW)

(72) Inventor: Hsu-Shen CHIN, New Taipei City (TW)

(21) Appl. No.: 18/130,916

(22) Filed: Apr. 5, 2023

(30) Foreign Application Priority Data
Aug. 16, 2022 (TW) 111130850

(51) Int. Cl. H01R 13/642; H01R 13/502; H01R 24/38; H01R 25/00

(52) U.S. Cl. CPC H01R 13/642; H01R 13/502; H01R 24/38; H01R 25/006; H01R 2105/00

(57) ABSTRACT

An electrical connector includes an upper insulating housing, a lower insulating housing, a first-polarity conductive terminal, a second-polarity conductive terminal, a central conductor, an inner conductor, a third-polarity conductive terminal, and an outer conductor. The central contact portion of the central conductor, the inner contact portion of the inner conductor and the outer contact portion of the outer conductor are sequentially arranged outside the lower insulating housing from inside to outside. The structural design of the contact interface does not have a specific assembling direction, so that the non-directional docking can be realized, and the assembly can be easily performed without restricting the circuit layout.

### CROSS REFERENCE

This application claims the priority of Taiwanese Patent Application No. 111130850, entitled “NON-DIRECTIONAL DOCKING ELECTRICAL CONNECTOR AND BASE THEREOF”, filed on Aug. 16, 2022, the disclosure of which is incorporated herein by reference in its entirety.

### FIELD OF THE DISCLOSURE

The present disclosure relates to an electrical connector assembly and a base thereof, and particularly to an electrical connector and a base thereof that can realize non-directional docking.

### BACKGROUND

With the increasing demand for high-speed cables and higher transmission rates in the market, the connectors have been paid more and more attention, and the requirements for connectors of different interfaces are also stricter. The structure of the contact interface determines the electrical and mechanical properties of the connector, such as resistance value, docking force, and durability. However, usually in the connector assembly, the connector and its base are connected in a specific direction, and the user can only assemble according to the set direction.

If the plugging operation is wrongly conducted, the pins of the connector will be damaged, and the electronic equipment will be broken. Therefore, in order to avoid plugging errors, which makes the connector assembly unable to operate normally, or to allow designers to carry out circuit layout without limitation, there is an urgent need for a connector assembly where there is no directional restriction between the connector and its base to solve the above issues.

In view of this, it is necessary to provide an electrical connector assembly and a base thereof to solve the conventional issues.

### SUMMARY

One objective of an embodiment of the present disclosure is to provide an electrical connector and a base thereof, to solve the above-mentioned issues.

According to an embodiment of the present disclosure, an electrical connector is disclosed. The electrical connector comprises: an upper insulating housing, having a first socket, a second socket and/or third socket; a lower insulating housing, connected with the upper insulating housing; a first-polarity conductive terminal, having a first elastic piece portion and a first connection portion, wherein the first elastic piece portion is correspondingly arranged with a first socket of the upper insulating housing; a second-polarity conductive terminal, having a second elastic piece portion and a second connecting portion, wherein the second elastic piece portion is arranged corresponding to a second socket of the upper insulating housing; a central conductor, electrically connected to the first connecting portion of the first polarity conductive terminal, having a central fixing portion and a central contact portion, wherein the central fixing portion allows the central conductor to be fixed on the lower insulating housing; an inner conductor, electrically connected to the second connection portion of the second polarity conductive terminal, having an inner fixing portion and an inner contact portion, wherein the inner fixing portion allows the inner conductor to be fixed on the lower insulating housing; and/or a third-polarity conductive terminal, having a third elastic piece portion and a third connecting portion, wherein the third elastic piece portion is correspondingly arranged with a third inserting socket of the upper insulating housing; and/or an outer conductor, electrically connected to the third connection portion of the third-polarity conductive terminal, having an outer fixing portion and an outer contact portion, wherein the outer fixing portion allows the outer conductor to be fixed on the lower insulating housing; wherein the central contact portion of the central conductor, the inner contact portion of the inner conductor and the outer contact portion of the outer conductor are sequentially arranged outside the lower insulating housing from inside to outside.

According to an embodiment of the present disclosure, a base is disclosed. The base includes a first insulating housing, a second insulating housing, a first conductor, a second conductor, and a third conductor. The first insulating housing includes a first socket, a second socket, and a third socket. The second insulating housing is connected with the first insulating housing. The first conductor includes a first contact portion and a first fixing portion. The first contact portion is arranged correspondingly to the first socket of the first insulating housing, and the first fixing portion allows the first conductor to be fixed between the first insulating housing and the second insulating housing. The second conductor includes a second contact portion and a second fixing portion. The second contact portion is arranged corresponding to the second socket of the first insulating housing, and the second fixing portion allows the second conductor to be fixed between the first insulating housing and the second insulating housing. The third conductor includes a third contact portion and a third fixing portion. The third contact portion is arranged correspondingly to the third socket of the first insulating housing, and the third fixing portion allows the third conductor to be fixed between the first insulating housing and the second insulating housing. The first contact portion of the first conductor, the second contact portion of the second conductor, and the third contact portion of the third conductor are sequentially disposed outside the first insulating housing from inside to outside.

According to an embodiment of the present disclosure, an electrical connector is disclosed. The electrical connector comprises: an upper insulating housing, having at least one socket; a lower insulating housing, having at least one slot, arranged under the upper insulating housing and connected with the upper insulating housing; and a central conductor, having a central elastic piece portion, a central fixing portion and a central docking portion, wherein the central elastic piece portion is arranged correspondingly to one socket of the upper insulating housing, the central fixing portion allows the central conductor to be fixed between the upper insulating housing and the lower insulating housing, and the central docking portion is arranged correspondingly to one slot of the lower insulating housing; an inner conductor, having an inner elastic piece portion, an inner fixing portion and an inner docking portion, wherein the inner elastic piece portion is arranged correspondingly to one socket of the upper insulating housing, the inner fixing portion allows the inner conductor to be fixed between the upper insulating housing and the lower insulating housing, and the inner docking portion is arranged correspondingly to one slot of the lower insulating housing; and/or an outer conductor, having an outer elastic piece portion, an outer fixing portion and an outer docking portion, wherein the outer elastic piece portion is arranged correspondingly to a socket of the upper insulating housing, and the outer fixing portion allows the outer conductor to be fixed between the upper insulating housing and the lower insulating housing, and the outer docking portion is arranged correspondingly to a slot of the lower insulating housing; wherein the central docking portion of the central conductor, the inner docking portion of the inner conductor and the outer docking portion of the outer conductor are sequentially disposed outside the lower insulating housing from inside to outside; wherein the lower insulating housing comprises a first protruding portion and a second protruding portion, the first protruding portion is disposed between the central docking portion of the central conductor and the inner docking portion of the inner conductor to form a center docking slot, and the second protruding portion is disposed between the inner docking portion of the inner conductor and the outer docking portion of the outer conductor to form an inner docking slot.

According to an embodiment of the present disclosure, a base is disclosed. The base comprises: a third insulating housing, having a first socket, a second socket and/or a third socket; a fourth insulating housing, connected with the third insulating housing; a first conductor, having a first contact portion and a first fixing portion, wherein the first contact portion is arranged correspondingly to the first socket of the third insulating housing, and the first fixing portion allows the first conductor to be fixed between the third insulating housing and the fourth insulating housing; a second conductor, having a second contact portion and a second fixing portion, the second contact portion is arranged corresponding to the second socket of the third insulating housing, and the second fixing portion allows the second conductor to be fixed between the third insulating housing and the fourth insulating housing; and/or a third conductor, having a third contact portion and a third fixing portion, the third contact portion is arranged correspondingly to the third socket of the third insulating housing, and the third fixing portion allows the third conductor to be fixed between the third insulating housing and the fourth insulating housing; wherein the first contact portion of the first conductor, the second contact portion of the second conductor, and the third contact portion of the third conductor are sequentially disposed outside the third insulating housing from inside to outside.

To sum up, embodiments of the present disclosure are directed to the electrical connector assembly and its base. The structural design of the contact interface does not have a specific assembling direction, so that the non-directional docking can be realized, and the assembly can be easily performed without restricting the circuit layout. Furthermore, it could save materials for the foolproof mechanism, and thus reduce the production cost.

These and other features, aspects and advantages of the present disclosure will become understood with reference to the following description, appended claims and accompanying figures.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a diagram of an electrical connector according to a first embodiment of the present disclosure.

FIG. 2 illustrates the electrical connector of FIG. 1 without an upper insulating housing.

FIG. 3 illustrates an exploded view of the electrical connector according to the first embodiment of the present disclosure.

FIG. 4 illustrates another view of the electrical connector illustrated in FIG. 1.

FIG. 5 is a top view of FIG. 4.

FIG. 6 is a diagram of an electronic connector according to a second embodiment of the present disclosure.

FIG. 7 is a diagram of an electrical connector according to a third embodiment of the present disclosure.

FIG. 8A is a diagram of a base according to a first embodiment of the present disclosure.

FIG. 8B is a top view of FIG. 8A.

FIG. 8C is a cross-sectional view taken along line A-A′ of FIG. 8B.

FIG. 8D is an exploded view of the base according to the first embodiment of the present disclosure.

FIG. 9A is a top view of a base according to a second embodiment of the present disclosure.

FIG. 9B is a cross-sectional view taken along the line B-B′ of FIG. 9A.

FIG. 10A is a top view of a base according to a third embodiment of the present disclosure.

FIG. 10B is a cross-sectional view taken along the line C-C′ of FIG. 10A.

FIG. 11A is a top view of a base according to a fourth embodiment of the present disclosure.

FIG. 11B is a cross-sectional view taken along the line D-D′ of FIG. 11A.

FIG. 12A is a top view of a base according to a fifth embodiment of the present disclosure.

FIG. 12B is a cross-sectional view along the line E-E′ of FIG. 12A.

FIG. 13A is a top view of a base according to a sixth embodiment of the present disclosure.

FIG. 13B is a cross-sectional view taken along the line F-F of FIG. 13A.

FIG. 14A is a top view of a base according to a seventh embodiment of the present disclosure.

FIG. 14B is a cross-sectional view along the line G-G′ of FIG. 14A.

FIG. 15A is a top view of a base according to the eighth embodiment of the present disclosure.

FIG. 15B is a cross-sectional view along the line G-G′ of FIG. 15A.

FIGS. 16-23 are cross-sectional views of the electrical connector assembly according to the first to eighth embodiments of the present disclosure.

FIG. 24A is a three-dimensional view of an electrical connector according to the fourth embodiment of the present disclosure.

FIG. 24B is a cross-sectional view of FIG. 24A.

FIG. 24C is three-dimensional view of an electrical connector according to the fourth embodiment of the present disclosure.

FIG. 24D is an exploded diagram of the fourth embodiment of the electrical connector of the present disclosure.

FIG. 25A is a three-dimensional view of an electrical connector according to the fifth embodiment of the present disclosure.

FIG. 25B is a cross-sectional view of FIG. 25A.

FIG. 26A depicts the electrical connector according to a sixth embodiment of the present disclosure.

FIG. 26B is a cross-sectional view of FIG. 26A.

FIG. 27A is a three-dimensional view of an electrical connector according to a seventh embodiment of the present disclosure.

FIG. 27B is a cross-sectional view of FIG. 27A.

FIG. 28A is a three-dimensional view of an electrical connector according to an eighth embodiment of the present disclosure.

FIG. 28B is a cross-sectional view of FIG. 28A.

FIG. 29A is a three-dimensional view of an electrical connector according to a ninth embodiment of the present disclosure.

FIG. 29B is a cross-sectional view of FIG. 29A.

FIG. 30A is a three-dimensional view of an electrical connector according to the tenth embodiment of the present disclosure.

FIG. 30B is a cross-sectional view of FIG. 30A.

FIG. 31A is a three-dimensional view of an electrical connector according to the eleventh embodiment of the present disclosure.

FIG. 31B is a cross-sectional view of FIG. 31A.

FIG. 32A is a three-dimensional view of an electrical connector according to the twelfth embodiment of the present disclosure.

FIG. 32B is a cross-sectional view of FIG. 32A.

FIG. 33A is a three-dimensional view of an electrical connector according to the thirteenth embodiment of the present disclosure.

FIG. 33B is a cross-sectional view of FIG. 33A.

FIG. 34A is a three-dimensional view of an electrical connector according to the fourteenth embodiment of the present disclosure.

FIG. 34B is a cross-sectional view of FIG. 34A.

FIG. 35A is a three-dimensional view of an electrical connector according to the fifteenth embodiment of the present disclosure.

FIG. 35B is a cross-sectional view of FIG. 34A.

FIG. 36A is a three-dimensional view of a base according to a ninth embodiment of the present disclosure.

FIG. 36B is a top view of FIG. 36A.

FIG. 36C is a cross-sectional view taken along line I-f of FIG. 36B.

FIG. 36D is an exploded view of the base according to the ninth embodiment of the present disclosure.

FIG. 37A is a three-dimensional view of a base according to the tenth embodiment of the present disclosure.

FIG. 37B is a cross-sectional view of FIG. 37A.

FIG. 38A is a three-dimensional view of a base according to the eleventh embodiment of the present disclosure.

FIG. 38B is a cross-sectional view of FIG. 38A.

FIG. 39 is a cross-sectional view of the base according to the twelfth embodiment of the present disclosure.

FIG. 40 is a cross-sectional view of the base according to the thirteenth embodiment of the present disclosure.

FIG. 41 is a cross-sectional view of the base according to the fourteenth embodiment of the present disclosure.

FIG. 42 is a cross-sectional view of the base according to the fifteenth embodiment of the present disclosure.

FIG. 43A is a three-dimensional view of the base according to the sixteenth embodiment of the present disclosure.

FIG. 43B is a top view of FIG. 43A.

FIG. 44 is a cross-sectional view of FIG. 43B.

FIG. 45 is a cross-sectional view of the electrical connector of FIG. 28B and the base of FIG. 37A after being assembled.

FIG. 46 is a cross-sectional view of the electrical connector of FIG. 28B and the base of FIG. 41 after being assembled.

FIG. 47 is a cross-sectional view of the electrical connector of FIG. 30A and the base of FIG. 43A after being assembled.

FIG. 48 is a cross-sectional view of the electrical connector of FIG. 31A and the base of FIG. 37A after being assembled.

FIG. 49 is a cross-sectional view of the electrical connector of FIG. 31A and the base of FIG. 40 after being assembled.

FIG. 50 is a cross-sectional view of the electrical connector of FIG. 33A and the base of FIG. 43A after being assembled.

FIG. 51 is a cross-sectional view of the electrical connector of FIG. 26A and the base of FIG. 37A after being assembled.

FIG. 52 is a cross-sectional view of the electrical connector of FIG. 26A and the base of FIG. 39 after being assembled.

FIG. 53 is a cross-sectional view of the electrical connector of FIG. 34A and the base of FIG. 43A after being assembled.

FIG. 54 is a cross-sectional view of the electrical connector of FIG. 27A and the base of FIG. 37A after being assembled.

FIG. 55 is a cross-sectional view of the electrical connector of FIG. 27A and the base of FIG. 42 after being assembled.

FIG. 56 is a cross-sectional view of the electrical connector of FIG. 35A and the base of FIG. 43A after being assembled.

FIG. 57 depicts the schematic perspective diagram of the electrical connector according to a sixteenth embodiment of the present disclosure.

FIG. 58 depicts the exploded diagram of the electrical connector according to the sixteenth embodiment of the present disclosure.

FIG. 59 illustrates a perspective view of the electrical connector according to the seventeenth embodiment of the present disclosure.

FIG. 60 illustrates a perspective view of the electrical connector according to the eighteenth embodiment of the present disclosure.

FIG. 61A illustrates a perspective view of the base according to the seventeenth embodiment of the present disclosure.

FIG. 61B illustrates a top view of the base illustrated in FIG. 61A.

FIG. 61C illustrates a cross-sectional view taken along line J-J′ of FIG. 61B.

FIG. 61D depicts an exploded diagram of the base according to the seventeenth embodiment of the present disclosure.

FIG. 62A illustrates a top view of the base according to the eighteenth embodiment of the present disclosure.

FIG. 62B illustrates a cross-sectional view taken along line K-K′ of FIG. 62A.

FIG. 63A illustrates a top view of the base according to the nineteenth embodiment of the present disclosure.

FIG. 63B illustrates a cross-sectional view taken along line L-L′ line of FIG. 63A.

FIG. 64A illustrates a top view of the base according to the twentieth embodiment of the present disclosure.

FIG. 64B illustrates a cross-sectional view taken along line M-M′ of FIG. 64A.

FIG. 65A illustrates a top view of the base according to the twenty-first embodiment of the present disclosure.

FIG. 65B is a cross-sectional view taken along line N-N′ line of FIG. 65A.

FIG. 66A illustrates a top view of the twenty-second embodiment of the base of the present disclosure.

FIG. 66B is a cross-sectional view taken along line O-O′ in FIG. 66A.

FIG. 67A illustrates a top view of the base according to the twenty-third embodiment of the present disclosure.

FIG. 67B is a cross-sectional view taken along line P-P′ in FIG. 67A.

FIG. 68A illustrates a top view of the base according to the twenty-fourth embodiment of the present disclosure.

The FIG. 68B is a cross-sectional view taken along line Q-Q′ in FIG. 68A.

FIG. 69 illustrates a cross-sectional view of the electrical connector assembly according to the ninth embodiment of the present disclosure.

FIG. 70 illustrates a cross-sectional view of the electrical connector assembly according to the tenth embodiment of the present disclosure.

FIG. 71 illustrates a cross-sectional view of the electrical connector assembly according to the eleventh embodiment of the present disclosure.

FIG. 72 illustrates a cross-sectional view of the electrical connector assembly according to the twelfth embodiment of the present disclosure.

FIG. 73 illustrates a cross-sectional view of the electrical connector assembly according to the thirteenth embodiment of the present disclosure.

FIG. 74 illustrates a cross-sectional view of the electrical connector assembly according to the fourteenth embodiment of the present disclosure.

FIG. 75 illustrates a cross-sectional view of the electrical connector assembly according to the fifteenth embodiment of the present disclosure.

FIG. 76 illustrates a cross-sectional view of the electrical connector assembly according to the sixteenth embodiment of the present disclosure.

FIG. 77A depicts the schematic perspective diagram of the electrical connector according to the nineteenth embodiment of the present disclosure.

FIG. 77B illustrates a cross-sectional view of FIG. 77A.

FIG. 77C depicts the exploded diagram of the electrical connector according to the nineteenth embodiment of the present disclosure.

FIG. 77D illustrates an exploded diagram from another perspective of the electrical connector according to the nineteenth embodiment of the present disclosure.

FIG. 78A depicts the schematic perspective diagram of the electrical connector according to the twentieth embodiment of the present disclosure.

FIG. 78B illustrates a cross-sectional view of FIG. 78A.

FIG. 79A depicts the schematic perspective diagram of the electrical connector according to the twenty-first embodiment of the present disclosure.

FIG. 79B illustrates a cross-sectional view of FIG. 79A.

FIG. 80A depicts the schematic perspective diagram of the electrical connector according to the twenty-second embodiment of the present disclosure.

FIG. 80B illustrates a cross-sectional view of FIG. 80A.

FIG. 81A depicts the schematic perspective diagram of the electrical connector according to the twenty-third embodiment of the present disclosure.

FIG. 81B illustrates a cross-sectional view of FIG. 81A.

FIG. 82A depicts the schematic perspective diagram of the electrical connector according to the twenty-fourth embodiment of the present disclosure.

FIG. 82B illustrates a cross-sectional view of FIG. 82A.

FIG. 83A depicts the schematic perspective diagram of the electrical connector according to the twenty-fifth embodiment of the present disclosure.

FIG. 83B illustrates a cross-sectional view of FIG. 83A.

FIG. 84A depicts the schematic perspective diagram of the electrical connector according to the twenty-sixth embodiment of the present disclosure.

FIG. 84B illustrates a cross-sectional view of FIG. 84A.

FIG. 85A illustrates the schematic perspective diagram of the electrical connector according to the twenty-seventh embodiment of the present disclosure.

FIG. 85B illustrates a cross-sectional view of FIG. 85A.

FIG. 86A depicts the schematic perspective diagram of the electrical connector according to the twenty-eighth embodiment of the present disclosure.

FIG. 86B illustrates a cross-sectional view of FIG. 86A.

FIG. 87A depicts the schematic perspective diagram of the electrical connector according to the twenty-ninth embodiment of the present disclosure.

FIG. 87B illustrates a cross-sectional view of FIG. 87A.

FIG. 88A illustrates the schematic perspective diagram of the electrical connector according to the thirtieth embodiment of the present disclosure.

FIG. 88B illustrates a cross-sectional view of FIG. 88A.

FIG. 89A depicts the schematic perspective diagram of the base according to the twenty-fifth embodiment of the present disclosure.

FIG. 89B illustrates a top view of FIG. 89A.

FIG. 89C illustrates a cross-sectional view taken along the line R-R′ in FIG. 89A.

FIG. 89D depicts an exploded diagram of the base according to the twenty-fifth embodiment of the present disclosure.

FIG. 90A depicts the schematic perspective diagram of the base according to the twenty-sixth embodiment of the present disclosure.

FIG. 90B illustrates a cross-sectional view of FIG. 90A.

FIG. 91A depicts the schematic perspective diagram of the base according to the twenty-seventh embodiment of the present disclosure.

FIG. 91B illustrates a cross-sectional view of FIG. 91A.

FIG. 92A depicts the schematic perspective diagram of the base according to the twenty-eighth embodiment of the present disclosure.

FIG. 92B illustrates a cross-sectional view of FIG. 92A.

FIG. 93 illustrates a cross-sectional view of the base according to the twenty-ninth embodiment of the present disclosure.

FIG. 94 illustrates a cross-sectional view of the base according to the thirtieth embodiment of the present disclosure.

FIG. 95 illustrates a cross-sectional view of the base according to the thirty-first embodiment of the present disclosure.

FIG. 96 depicts the perspective diagram of the base according to the thirty-second embodiment of the present disclosure.

FIG. 97A depicts the schematic perspective diagram of the electrical connector according to the thirty-first embodiment of the present disclosure.

FIG. 97B illustrates the top view of FIG. 97A.

FIG. 97C depicts an exploded diagram of the electrical connector according to the thirty-first embodiment of the present disclosure.

FIG. 98 depicts an exploded diagram of the electrical connector according to the thirty-second embodiment of the present disclosure.

FIG. 99 illustrates a perspective view of the electrical connector according to the thirty-third embodiment of the present disclosure.

FIG. 100 illustrates a perspective view of the electrical connector according to the thirty-fourth embodiment of the present disclosure.

FIG. 101A illustrates a perspective view of the base according to the thirty-third embodiment of the present disclosure.

FIG. 101B illustrates the top view of FIG. 101A.

FIG. 101C illustrates a cross-sectional view taken along line S-S′ in FIG. 101B.

FIG. 101D depicts an exploded diagram of the base according to the thirty-third embodiment of the present disclosure.

FIG. 102A illustrates a top view of the base according to the thirty-fourth embodiment of the present disclosure.

FIG. 102B illustrates a cross-sectional view taken along line T-T′ in FIG. 102A.

FIG. 103A illustrates a top view of the base according to the thirty-fifth embodiment of the present disclosure.

FIG. 103B illustrates a cross-sectional view taken along line U-U′ in FIG. 103A.

FIG. 104A illustrates a top view of the base according to the thirty-sixth embodiment of the present disclosure.

FIG. 104B illustrates a cross-sectional view taken along line V-V′ in FIG. 104A.

FIG. 105A illustrates a top view of the electrical connector according to the thirty-fifth embodiment of the present disclosure.

FIG. 105B is a cross-sectional view of FIG. 105A.

FIG. 105C depicts an exploded diagram of the electrical connector according to the thirty-fifth embodiment of the present disclosure.

FIG. 105D illustrates another perspective exploded diagram of the electrical connector according to the thirty-fifth embodiment of the present disclosure.

FIG. 106A illustrates a top view of the electrical connector according to the thirty-sixth embodiment of the present disclosure.

FIG. 106B is a cross-sectional view of FIG. 106A.

FIG. 107A illustrates a top view of the electrical connector according to the thirty-seventh embodiment of the present disclosure.

FIG. 107B is a cross-sectional view of FIG. 107A.

FIG. 108A illustrates a top view of the electrical connector according to the thirty-eighth embodiment of the present disclosure.

FIG. 108B is a cross-sectional view of FIG. 108A.

FIG. 109A depicts schematic perspective diagram of the base according to the thirty-seventh embodiment of the present disclosure.

FIG. 109B illustrates a top view of FIG. 109A.

FIG. 109C illustrates a top view taken along line W-W′ in FIG. 109B.

FIG. 109D depicts an exploded diagram of the base according to the thirty-seventh embodiment of the present disclosure.

FIG. 110A illustrates a top view of the base according to the thirty-eighth embodiment of the present disclosure.

FIG. 110B illustrates a cross-sectional view taken along line X-X′ in FIG. 110A.

FIG. 111A illustrates a top view of the base according to the thirty-ninth embodiment of the present disclosure.

FIG. 111B illustrates a cross-sectional view taken along line Y-Y′ in FIG. 111A.

FIG. 112A illustrates a top view of the base according to the fortieth embodiment of the present disclosure.

FIG. 112B illustrates a cross-sectional view taken along line Z-Z′ in FIG. 112A.

FIG. 113A illustrates a top view of the base according to the forty-first embodiment of the present disclosure.

FIG. 113B illustrates a cross-sectional view taken along line A1-A1′ in FIG. 113A.

FIG. 114A illustrates a top view of the base according to the forty-second embodiment of the present disclosure.

FIG. 114B illustrates a cross-sectional view taken along line B1-B1′ in FIG. 114A.

FIG. 115A illustrates a top view of the base according to the forty-third embodiment of the present disclosure.

FIG. 115B illustrates a cross-sectional view taken along line C1-C1′ in FIG. 115A.

FIG. 116A illustrates a top view of the base according to the forty-fourth embodiment of the present disclosure.

FIG. 116B illustrates a cross-sectional view taken along line D1-D1′ in FIG. 116A.

FIG. 117A illustrates a top view of the base according to the forty-fifth embodiment of the present disclosure.

FIG. 117B illustrates a cross-sectional view taken along line E1-E1′ in FIG. 117A.

FIG. 118A illustrates a top view of the base according to the forty-sixth embodiment of the present disclosure.

FIG. 118B illustrates a cross-sectional view taken along line F1-F1′ in FIG. 118A.

FIG. 119A depicts a schematic perspective diagram of the electrical connector according to the thirty-ninth embodiment of the present disclosure.

FIG. 119B illustrates a top view of FIG. 119A.

FIG. 120A depicts the schematic perspective diagram of the electrical connector according to the fortieth embodiment of the present disclosure.

FIG. 120B illustrates a top view of FIG. 120A.

FIG. 121 illustrates a top view of the electrical connector according to the forty-first embodiment of the present disclosure.

FIG. 122 illustrates a top view of the electrical connector according to the forty-second embodiment of the present disclosure.

FIG. 123 illustrates a top view of the electrical connector according to the forty-third embodiment of the present disclosure.

FIG. 124 is a top view of jacks of various specifications applicable to the electrical connectors of each embodiment of the present disclosure.

### DETAILED DESCRIPTION

In order to facilitate understanding the technical features, content and advantages of the invention and the efficacy it can achieve, the present disclosure is hereby combined with the accompanying drawings, and the expression of the embodiment is described in detail as follows, and the scheme used therein, the main purpose of which is only for illustrative and auxiliary explanation purposes, may not be the true proportion and precise configuration of the embodiment of the present disclosure, so the proportion and configuration relationship of the attached drawing should not be interpreted, limiting the scope of rights of the invention in the actual implementation.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

The following will refer to the relevant drawings, illustrating various embodiments of the electrical connector and base according to the present disclosure, for ease of understanding, the same components in the following embodiments are illustrated by the same symbols.

Please refer to FIGS. 1-5. FIGS. 1-5 show an electrical connector 100 according to a first embodiment of the present disclosure. The electrical connector 100 comprises an upper insulating housing 110, a lower insulating housing 120, a terminal member and a conductor member. The lower insulating housing 120 is disposed under the upper insulating housing 110 and connected with the upper insulating housing 110 to form a cavity for accommodating the terminal member and the conductor member.

The upper insulating housing 110 comprises at least one socket 111, which can be connected with other electronic devices. As shown in FIG. 1, the upper insulating housing 110 is provided with three sockets 111a, 111b, 111c, and the electrical connector 100 is an outlet. Please note, the shape and number of the sockets 111 are not limited thereto. In some embodiments, the number of the sockets 111 can be one or two, and the shape can be square or circular, as long as the sockets 111 meet the needs of users. In this embodiment, the electrical connector 100 is a three-dimensional block-shaped outlet that can be movably assembled, but it is not limited thereto. In other embodiments, the electrical connector 100 can be disposed in an electronic device or a connecting wire, and can be flexibly used in circuit layout.

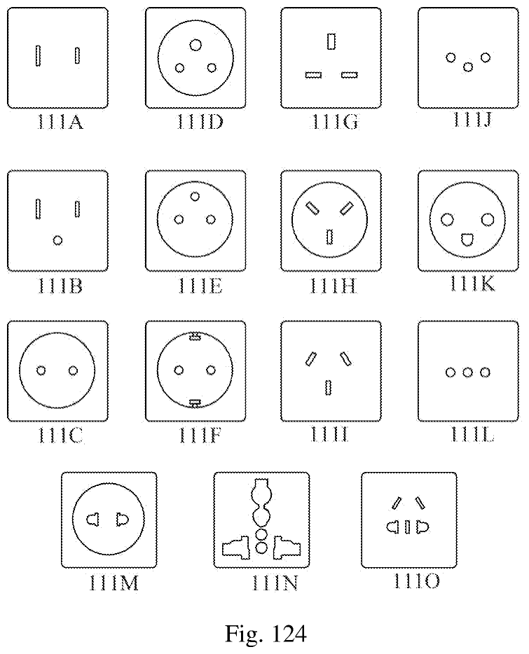

FIG. 124 depicts a top view of various sockets 111 that can be used in the electrical connector 100 shown in FIG. 1. The electronic device can insert its plug into the socket 111 to obtain the power supply. As shown in FIG. 124, the socket 111 can be a power jack of 100-420V or 200-240V, and the socket 111 can be a power jack of different specifications, such as Type A power jack 111A, Type B power jack 111B, Type C power jack 111C, Type D power jack 111D, Type E power jack 111E, Type F power jack 111F, Type G power jack 111G, Type H power jack 111H, Type I power jack Socket 111I, Type J power jack 111J, Type K power jack 111K, Type L power jack 111L and other power jacks of different specifications, or universal power jacks, such as Type A and Type C universal jack 111M, multi-country universal jacks 111N and 1110, etc.

In addition, the socket 111 can also be a Universal Serial Bus (USB) socket 111, which is used to supply power to electronic devices using buses of USB2.0, USB 2.0 Standard A, USB 2.0 Type C, USB3.0 and USB3.1, etc.

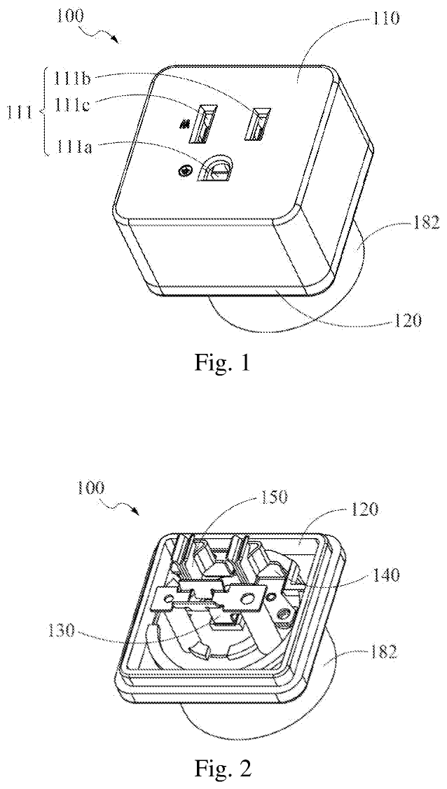

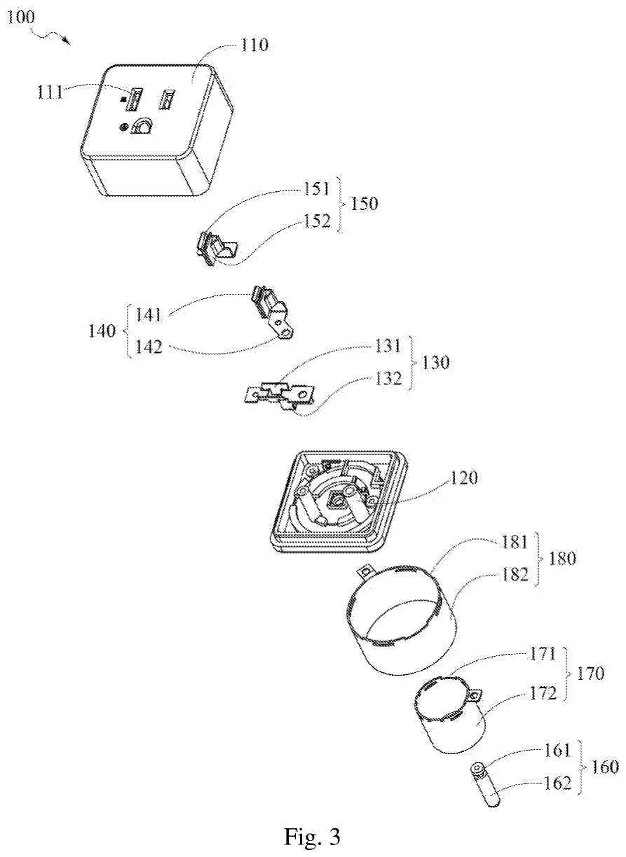

Please continue to refer to FIGS. 1-5. The terminal member is disposed between the upper insulating housing 110 and the lower insulating housing 120. In the three-dimensional schematic diagram shown in FIG. 2, the upper insulating housing 110 of the electrical connector 100 is removed, and the internal terminal member can be clearly seen. The terminal member comprises a first-polarity conductive terminal 130, a second-polarity conductive terminal 140 and a third-polarity conductive terminal 150. As shown in FIG. 3, the first-polarity conductive terminal 130 comprises a first elastic piece portion 131 and a first connecting portion 132. The first elastic piece portion 131 is arranged correspondingly to the first socket 111a of the upper insulating housing 110. The second-polarity conductive terminal 140 comprises a second elastic piece portion 141 and a second connecting portion 142. The second elastic piece portion 141 is arranged corresponding to the second socket 111b of the upper insulating housing 110. The third-polarity conductive terminal 150 comprises a third elastic piece portion 151 and a third connecting portion 152. The third elastic piece portion 151 is arranged corresponding to the third socket 111c of the upper insulating housing 110. When the electrical connector 100 is docked with other electronic devices, the pins of the electronic device will pass through the sockets 111a, 111b, 111c of the upper insulating housing 110 and connect with the first elastic piece 131, the second elastic piece 141 and the third elastic piece 151.

Specifically, the structure or number of the terminal members, their corresponding uses, and the manner in which the terminal members are fixed between the upper insulating housing 110 and the lower insulating housing 120 are not limited thereto. In this embodiment, the first-polarity conductive terminal 130 is electrically connected to the ground wire, the second-polarity conductive terminal 140 is electrically connected to the live wire, and the third-polarity conductive terminal 150 is electrically connected to the neutral wire. However, in some embodiments, depending on the specifications of the sockets or specific pins of the connected electronic devices, the structure of the terminal components will be different, and the way to fix the terminals between the upper insulating housing 110 and the lower insulating housing 120 will also be adjusted accordingly.

The conductor member passes through the lower insulating housing 120 and comprises a center conductor 160, an inner conductor 170 and an outer conductor 180. As shown in FIG. 3, the central conductor 160 is electrically connected to the first connecting portion 132 of the first-polarity conductive terminal 130 and comprises a central fixing portion 161 and a central contact portion 162. The central fixing portion 161 allows the central conductor 160 to be fixed on the bottom Insulating housing 120. The inner conductor 170 is electrically connected to the second connection portion 142 of the second-polarity conductive terminal 140 and comprises an inner fixing portion 171 and an inner contact portion 172. The outer conductor 180 is electrically connected to the third connection portion 152 of the third-polarity conductive terminal 150 and comprises an outer fixing portion 181 and an outer contact portion 182. The manner for the conductor member to be fixed to the lower insulating housing 120 is not limited here.

The terminal member and the conductor member can be electrically connected to each other by direct contact, welding contact or screw locking contact. However, in some embodiments, the electrical connection may also be achieved in a non-contact manner Or, the conductor member and the corresponding terminal member are integrally formed and are disposed between the upper insulating housing 110 and the lower insulating housing 120 and pass through the lower insulating housing 120.

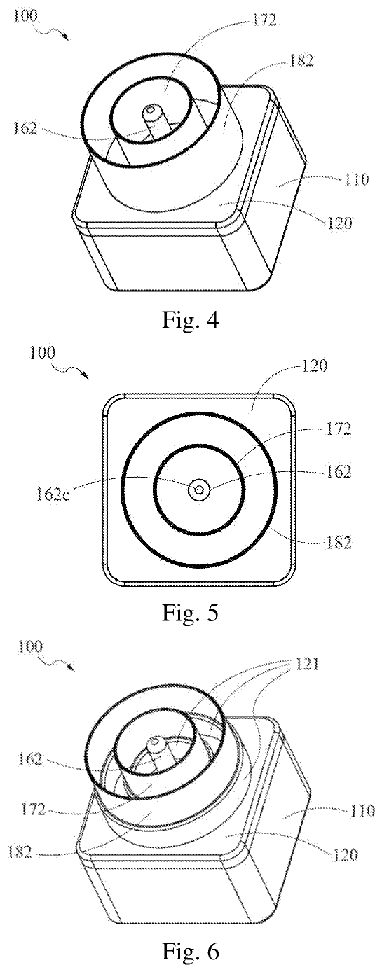

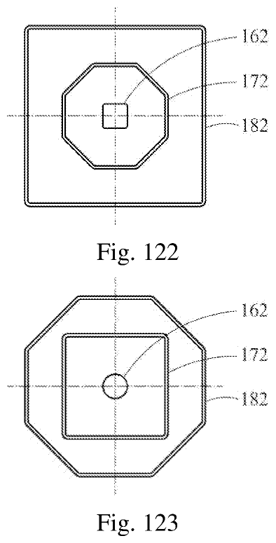

Please refer to FIG. 4 and FIG. 5. The center contact portion 162 of the center conductor 160, the inner contact portion 172 of the inner conductor 170 and the outer contact portion 182 of the outer conductor 180 are sequentially disposed outside the lower insulating housing 120 from inside to outside. As shown in FIG. 5, the structure of the contact portion of the lower insulating housing 120 is a concentric circle, a three-ring structure arranged from inside to outside. However, the shape of the contact portion is not limited here. That is, the center 162c of the central contact portion 162, the center of the inner contact portion 172 and the center of the outer contact portion 182 coincide with each other. The central contact portion 162, the inner contact portion 172 and the outer contact portion 182 are X-axis symmetric and Y-axis symmetric. Therefore, the shape could be a circle, a square, or any other regular polygons having sides of a multiple of four. In addition, the shapes and the numbers of sides of the center contact portion 162, the inner contact portion 172, and the outer contact portion 182 may be different from each other. For example, the central contact portion 162 may be a regular octagon, and both the inner contact portion 172 and the outer contact portion 182 may also be regular octagons, as shown in FIG. 121. Alternatively, the central contact portion 162 is a square, the inner contact portion 172 is a regular octagon, and the outer contact portion 182 is a square, as shown in FIG. 122. Alternatively, the central contact portion 162 is circular, the inner contact portion 172 is a square, and the outer contact portion 182 is a regular octagon, as shown in FIG. 123.

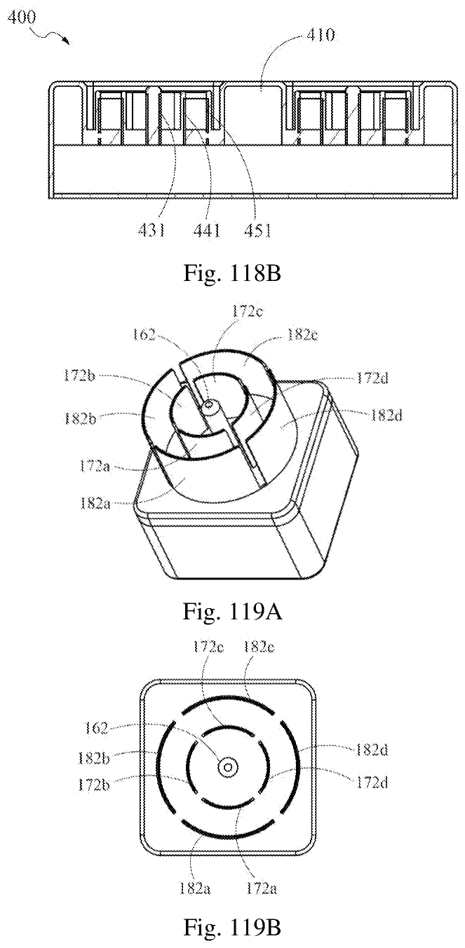

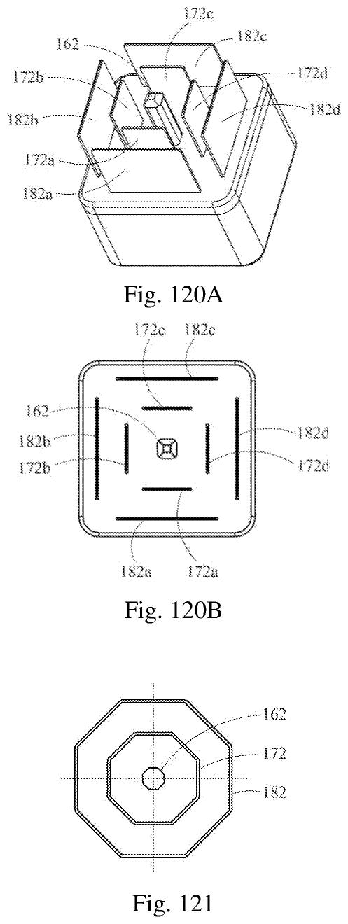

In detail, the contact portion can be arranged in a discontinuous ring, as long as the connected graphs are also symmetrical on the X axis and the Y axis, and the distance between each contact portion of the inner contact portion 172 and their center point and the distance between each contact portion of the outer contact portion 182 and their center point are all same. For example, the central contact portion 162 may be circular, and the inner contact portion 172 and the outer contact portion 182 may both be circular, but the contact portions 172a, 172b, 172c, 172d of the inner contact portion 172 are not connected to each other and the respective contact portions 182a, 182b, 182c, 182d in the external contact portion 182 are also not connected to each other, as shown in FIGS. 119A and 119B. Or, the central contact portion 162 is a square, the inner contact portion 172 and the outer contact portion 182 are both squares, but the respective contact portions 172a, 172b, 172c, 172d in the inner contact portion 172 are not connected and the contact portions 182a, 182b, 182c, 182d of the outer contact portion 182 are also not connected, as shown in FIG. 120A and FIG. 120B. In addition, the number of contact portions in the inner contact portion 172 and the outer contact portion 182 is not limited. Although the structures of these contact portions are not complete circles or regular polygons in a bottom view, no matter whether they are continuous figures or not, as long as the positions of the figures connected by the contact portions are the same, these electrical connectors 100 can fit the bases of corresponding specifications or other electronic devices. This can realize non-directional docking, which not only facilitates the operation, but also greatly improves the flexibility of the circuit layout.

Please refer to FIG. 6. FIG. 6 is a diagram of the electronic connector 100 according to a second embodiment of the present disclosure. The lower insulating housing 120 further comprises an extension portion 121 disposed on the outer side of the outer contact portion 182 of the outer conductor 180, between the central contact portion 172 of the central conductor 170 and the inner contact portion 162 of the inner conductor 160, and between the inner contact portion 162 of the inner conductor 160 and the outer contact portion 172 of the outer conductor 170. The extension portions 121 are in contact with the inner contact portion 162, the central contact portion 172 and the outer contact portion 182. The extension portions 121 can form an insulating shield when the electrical connector 100 is assembled with its base, or when docked with other electronic devices, so as to ensure that the electrical connector 100 maintains a certain performance in transmission. Here, the number of the extension portions 121 is not limited, and the shape of the extension portion 121 can also be adjusted according to the specification of the conductor member.

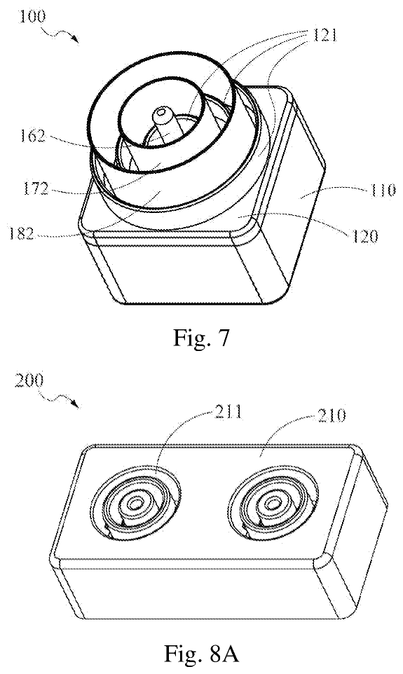

Please refer to FIG. 7. FIG. 7 is a diagram of the electrical connector 100 according to a third embodiment of the present disclosure. Different from FIG. 6, the extension portions 121 shown in FIG. 7 do not contact the inner contact portion 162, the center contact portion 172 and the outer contact portion 182, but maintains a distance from the inner contact portion 162, the center contact portion 172, and the outer contact portion 182.

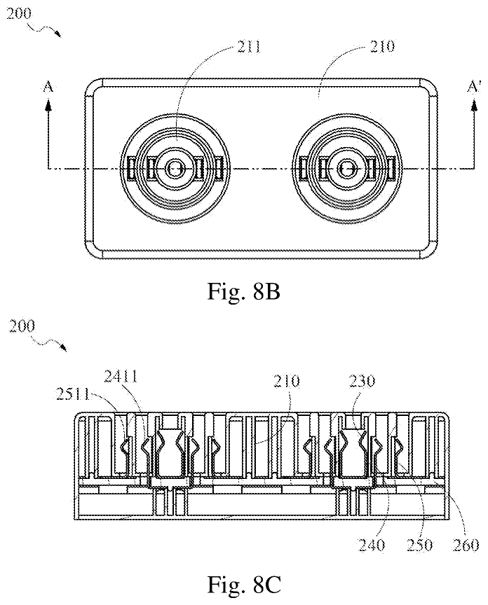

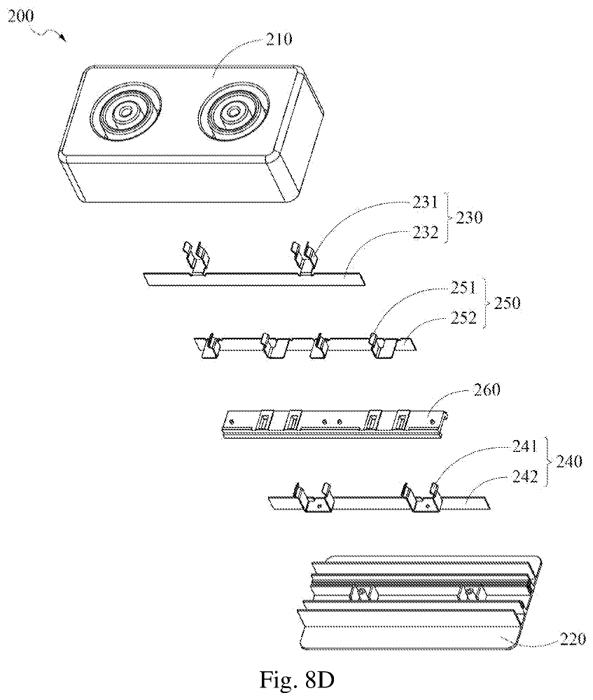

Please refer to FIGS. 8A to 8D. FIG. 8A is a diagram of a base 200 according to a first embodiment of the present disclosure. FIG. 8B is a top view of FIG. 8A. FIG. 8C is a cross-sectional view taken along line A-A′ of FIG. 8B. FIG. 8D is an exploded view of the base 200. The base 200 comprises a first insulating housing 210, a second insulating housing 220 and a conductor member. The first insulating housing 210 has at least one socket 211. The second insulating housing 220 is disposed under the first insulating housing 210 and connected with the first insulating housing 210 to form a cavity for accommodating the conductor members. In this embodiment, the upper insulating housing 210 of the base 200 comprises two sets of sockets 211, but the number of sets of sockets 211 is not limited thereto. Furthermore, the arrangement of the sockets 211 is not limited here.

The conductor member is disposed between the first insulating housing 210 and the second insulating housing 220 and comprises a first conductor 230, a second conductor 240 and a third conductor 250. As shown in FIG. 8C, the first conductor 230 comprises a first docking portion 231 and a first fixing portion 232. The first docking portion 231 is disposed correspondingly to a socket 211 of the first insulating housing 210, and the first fixing portion 232 allows the first conductor 230 to be fixed between the first insulating housing 210 and the second insulating housing 220. The second conductor 240 comprises a second docking portion 241 and a second fixing portion 242. The second docking portion 241 is disposed correspondingly to a socket 211 of the first insulating housing 210, and the second fixing portion 242 allows the second conductor 240 to be fixed between the first insulating housing 210 and the second insulating housing 220. The third conductor 250 comprises a third docking portion 251 and a third fixing portion 252. The third docking portion 251 is disposed correspondingly to a socket 211 of the first insulating housing 210, and the third fixing portion 252 allows the third conductor 250 to be fixed between the insulating housing 210 and the second insulating housing 220. Here, the specification of the conductor member and the manner of fixing the conductor member between the first insulating housing 210 and the second insulating housing 220 are not limited here.

The present disclosure further discloses an electrical connector assembly 10, which comprises an electrical connector 100 and a base 200. When the electrical connector 100 is assembled with the base 200, the central contact portion 162 of the central conductor 160 passes through the socket 211 corresponding to the first conductor 230 in the first insulating housing 210 and is electrically connected to the first docking portion 231. In addition, the inner contact portion 172 of the inner conductor 170 passes through the socket 211 corresponding to the second conductor 240 in the first insulating housing 210 and is electrically connected to the second docking portion 241. Furthermore, the outer contact portion 182 of the outer conductor 180 passes through the socket 211 corresponding to the third conductor 250 in the insulating housing 210 and is electrically connected to the third docking portion 251. In order to electrically connect the conductor member disposed in the base 200 with the docked electrical connector 100, the contact surface of the docking portion is exposed to the socket 211 of the first insulating housing 210 so as to directly contact the contact portion of the electrical connector 100 such that the electrical connection could be established.

As shown in FIG. 8D, the base 200 further comprises a spacer 260 disposed between the first conductor 210 and the second conductor 220 to form an insulating shield, so that the base 200 can maintain a certain transmission performance and prolong its life. Likewise, the structure, the fixing method, and the assembling method of the spacer 260 with the first conductor 210 and the second conductor 220 are not limited here.

As shown in FIG. 8B and FIG. 8C, the second docking portion 241 of the second conductor 240 has a second contact surface 2411, which is disposed correspondingly to the socket 211 corresponding to the second conductor 240. The third docking portion 251 of the third conductor 250 has a third contact surface 2511. The third contact surface 2511 is disposed corresponding to the socket 211, which is disposed correspondingly to the socket 211 corresponding to the third conductor 250. In this embodiment, when the first conductor 230 is the center, the second contact surface 2411 faces outward. That is, the second contact surface 2411 is exposed in a direction away from the center of the first conductor 230, and the third contact surface 2511 also faces outward.

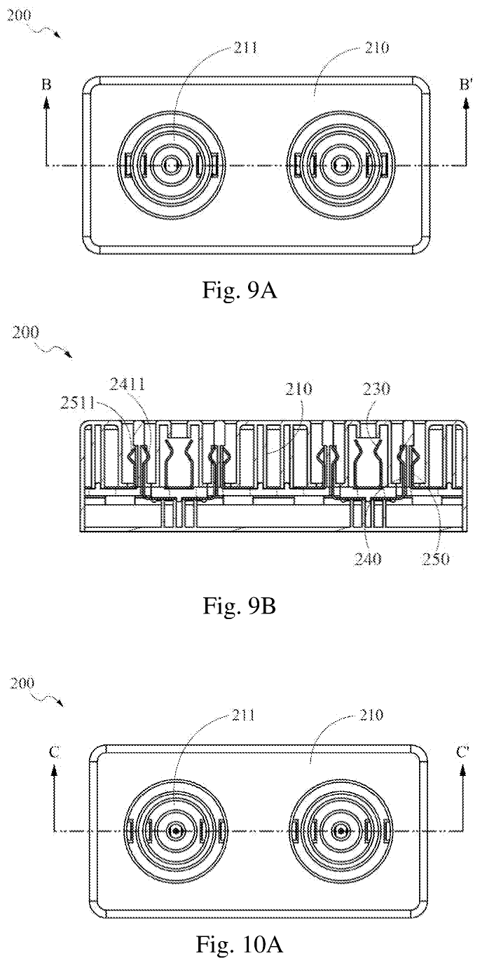

Please refer to FIG. 9A and FIG. 9B. FIG. 9A is a top view of the base 200 according to a second embodiment of the present disclosure. FIG. 9B is a cross-sectional view taken along the line B-B′ of FIG. 9A. When taking the first conductor 230 as the center, the second contact surface 2411 of the second docking portion 241 faces inward. That is, the second contact surface 2411 is exposed in the direction close to the first conductor 230. The third contact surface 2511 of the third docking portion 251 faces outward, which means that the third contact surface 2511 is exposed in a direction away from the first conductor 230.

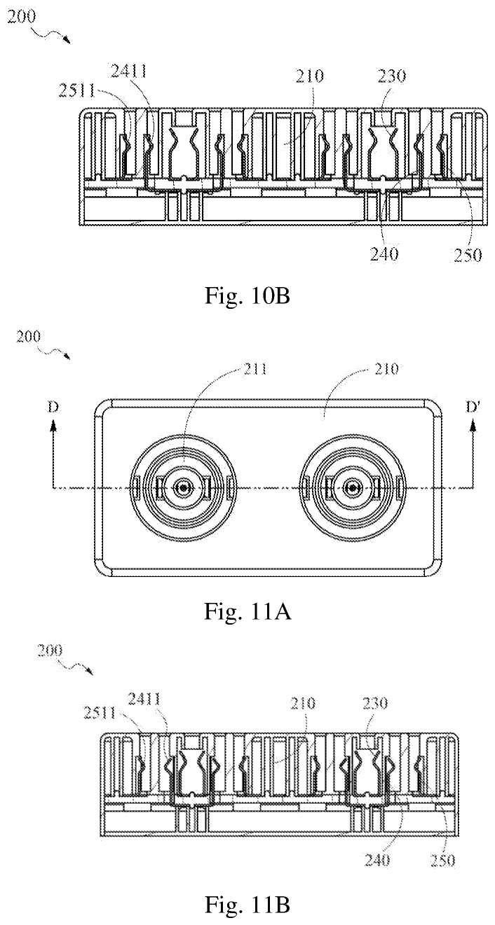

Please refer to FIG. 10A and FIG. 10B. FIG. 10A is a top view of the base 200 according to a third embodiment of the present disclosure. FIG. 10B is a cross-sectional view taken along the line C-C′ of FIG. 10A. With the first conductor 230 as the center, the second contact surface 2411 and the third contact surface 2511 both face inward and are exposed in a direction close to the first conductor 230.

Please refer to FIG. 11A and FIG. 11B. FIG. 11A is a top view of the base 200 according to a fourth embodiment of the present disclosure. FIG. 11B is a cross-sectional view taken along the line D-D′ of FIG. 11A. With the first conductor 230 as the center, the second contact surface 2411 faces outward and is exposed in a direction away from the first conductor 230, and the third contact surface 2511 faces inward and is exposed in a direction close to the first conductor 230. When the contact surface faces inward, only a part of the docking portions, the second contact surface 2411 of the second conductor 240 and the third contact surface 2511 of the third conductor 250, is exposed. This structure utilizes the structure of the first insulating housing 210 to protect the conductor members but could still establish the electrical connection with the electrical connector 100.

The electrical connector 100 shown in FIG. 6 can be correspondingly inserted into the base 200 shown in FIGS. 8A-11A.

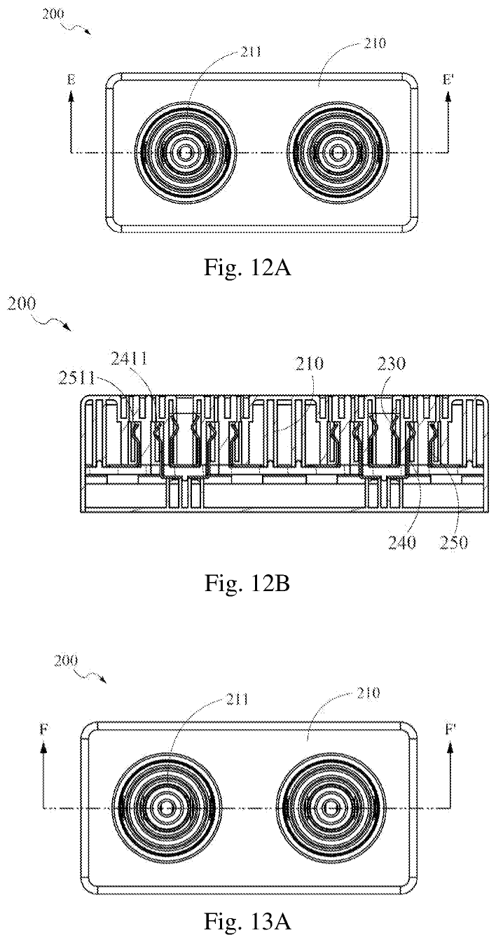

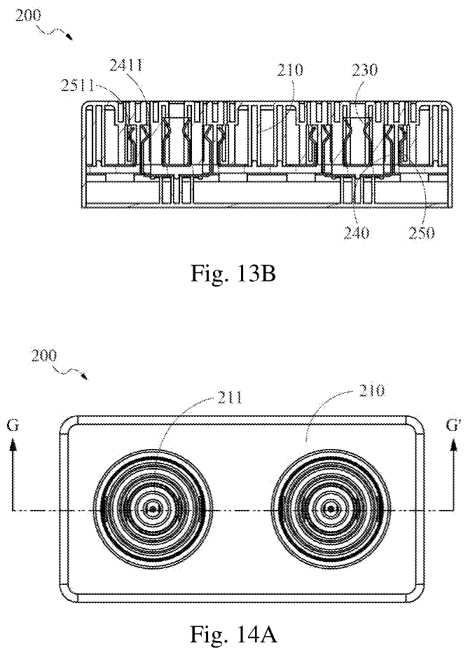

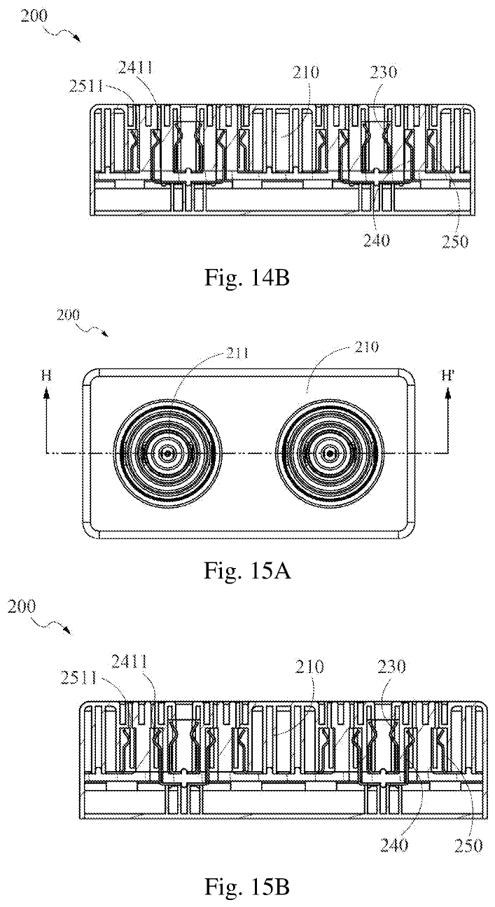

Please refer to FIGS. 12A, 12B, 13A, 13B, 14A, 14B, 15A, and 15B. FIG. 12A is a top view of the base 200 according to a fifth embodiment of the present disclosure. FIG. 12B is a cross-sectional view along the line E-E′ of FIG. 12A. FIG. 13A is a top view of the base 200 according to a sixth embodiment of the present disclosure. FIG. 13B is a cross-sectional view taken along the line F-F of FIG. 13A. FIG. 14A is a top view of the base 200 according to a seventh embodiment of the present disclosure. FIG. 14B is a cross-sectional view along the line G-G′ of FIG. 14A. FIG. 15A is a top view of the base 200 according to the eighth embodiment of the present disclosure. FIG. 15B is a cross-sectional view along the line G-G′ of FIG. 15A. Different from the base 200 shown in FIGS. 8A, 8B, 9A, 9B, 10A, 10B, 11A and 11B, the electrical connector 100 shown in FIG. 7 can be inserted into the base 200 shown in FIGS. 12A, 12B, 13A, 13B, 14A, 14B, 15A and 15B.

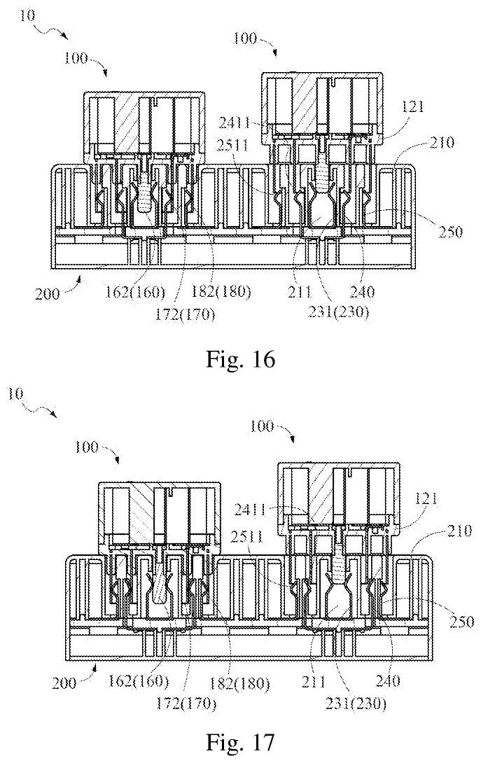

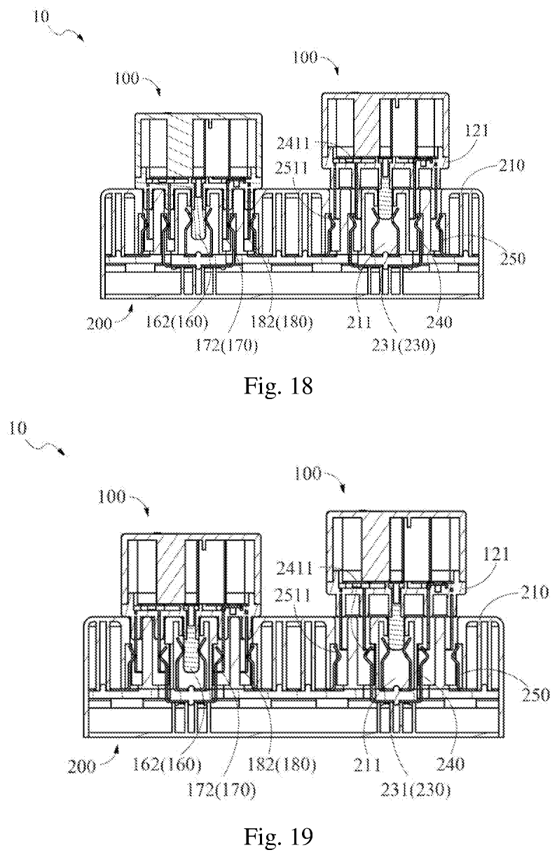

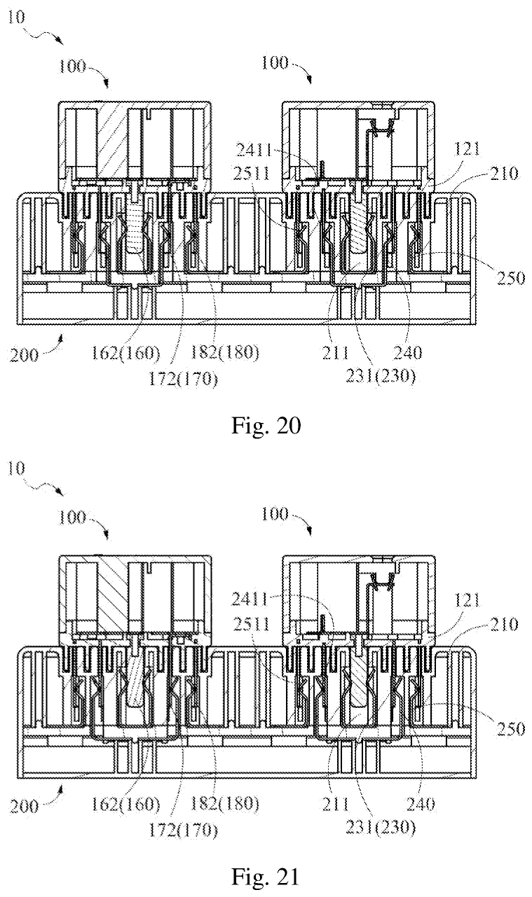

Please refer to FIGS. 16-23. FIGS. 16-23 are cross-sectional views of the electrical connector assembly 10 according to the first to eighth embodiments of the present disclosure. FIGS. 16-19 show the electrical connector 100 shown in FIG. 6 (with the extension portion 121) of the first embodiment and the docking bases 200 are the bases 200 of the first to fourth embodiments, respectively. FIGS. 20-23 show the electrical connector 100 shown in FIG. 7 (with the extension portion 121) of the second embodiment and the docking bases 200 of the fifth to eighth embodiments, respectively. The internal structures of the electrical connector 100 and the base 200 are as described above, and will not be repeated here. For the components not mentioned in the following paragraphs, the reference numerals will be omitted accordingly. As shown in FIGS. 16-23, the central conductor 160 of the electrical connector 100 is cylindrical. During assembly, the central contact portion 162 passes through the socket 211 corresponding to the first conductor 230 in the first insulating housing 210 and directly contacts the first docking portion 231 of the first conductor 230. The sheet-shaped first docking portion 231 sandwiches the central contact portion 162 to hold the central contact portion 162 to form an electrical connection. At the same time, the inner contact portion 172 and the outer contact portion 182 also pass through the sockets 211 corresponding to the second conductor 240 and the third conductor 250 respectively. If the second contact surface 2411 or the third contact surface 2511 faces inward, the second contact surface 2411 or the third contact surface 2511 directly contacts the outer sidewalls of the inner contact portion 172 or the outer contact portion 182. If the second contact surface 2411 or the third contact surface 2511 faces outward, the second contact surface 2411 or the third contact surface 2511 directly contacts the inner sidewalls of the inner contact portion 172 or the outer contact portion 182.

When the electrical connector 100 is assembled with the base 200, due to the structure of the first insulating housing 210, under the condition that the second contact surface 2411 and the third contact surface 2511 face the center direction, the spring-shaped second docking portion 241 and the third docking portion 251 only exposes the second contact surface 2411 and the third contact surface 2511 in the corresponding sockets 211. This structure can protect the lateral force of the docking portion, so as to avoid the conductor member of the base 200 being deformed due to excessive extrusion from the repeated insertion of the electrical connector 100. Thus, this could prolong the life of the base 200.

Furthermore, when the electrical connector 100 provided with the extension portion 121 is docked with the base 200, on the premise that the length of the conductor member remains unchanged (compared with the electrical connector 100 of the first embodiment), because the extension portion 121 of the lower insulating housing 120 is included, the portion of the conductor member inserted into the first insulating housing 210 is reduced. This result in the reduced contact areas between the center contact portion 162, the inner contact portion 172 and the outer contact portion 182 and the first docking portion 231, the second docking portion 241 and the third docking portion 251. Taking FIGS. 16-20 as an example, the first docking portion 231, the second docking portion 241 and the third docking portion 251 only directly contact the front edges of the central contact portion 162, the inner contact portion 172 and the outer contact portion 182. However, as long as there is sufficient contact area between the conductor members of the connector 100 and the conductor members of the base 200, the electrical connection can be established. Such a contact manner greatly reduces the lateral force on the docking portion and can further prolong the life of the electrical connector assembly 10.

In addition, the contact portion of the electrical connector 100 has structural adjustment. The shape and number of sides of the central contact portion 162, the inner contact portion 172 and the outer contact portion 182 may be different from each other. Therefore, the shape of the sockets 211 corresponding to the base 200 assembled with the electrical connector 100 of these embodiments will also be correspondingly different. For example, if the socket 211 corresponding to the center conductor 160 is in a square shape, the outer sidewall of the socket 211 corresponding to the inner conductor 170 is in a square shape and its inner sidewall is circular, and the outer sidewall of the socket 211 corresponding to the outer conductor 180 is in a square shape and its inner sidewall is a circular. Accordingly, the base 200 can accommodate the electrical connector 100 with a circular or square contact portion, so that the circuit layout has a better flexibility.

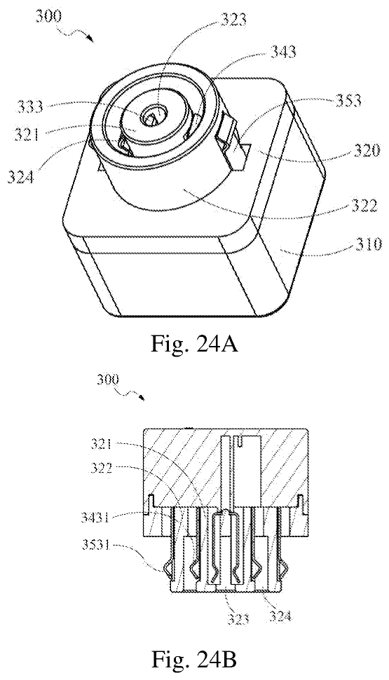

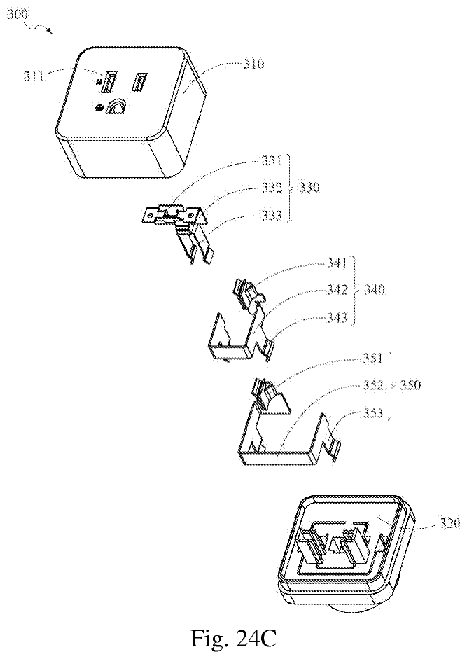

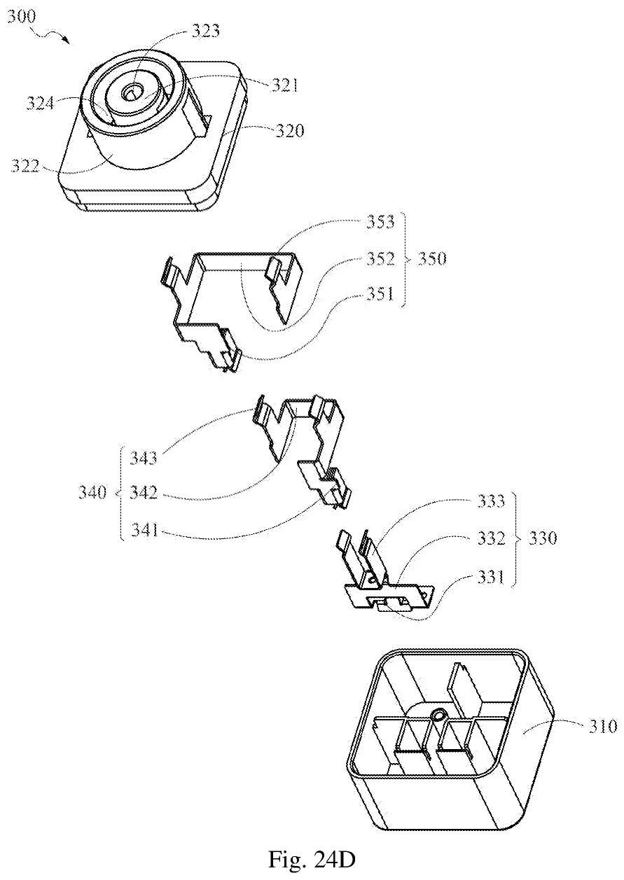

Please refer to FIGS. 24A-24D. FIG. 24A is a three-dimensional view of the electrical connector 300 according to the fourth embodiment of the present disclosure. FIG. 24B is a cross-sectional view of FIG. 24A. FIG. 24C is three-dimensional view of the electrical connector according to the fourth embodiment of the present disclosure. FIG. 24D is an exploded diagram of the fourth embodiment of the electrical connector of the present disclosure. In this embodiment, the electrical connector 300 includes an upper insulating housing 310, a lower insulating housing 320 and a conductor member. The lower insulating housing 320 has at least one slot, which is disposed below the upper insulating housing 310 and is connected with the upper insulating housing 310 to form a cavity for accommodating the conductor members. The upper insulating housing 310 has at least one socket 311. The electrical connector 300 is a movable socket block, which can be connected with other electronic devices. The specification of the socket interface is not limited here and can be adjusted according to the needs of the user.

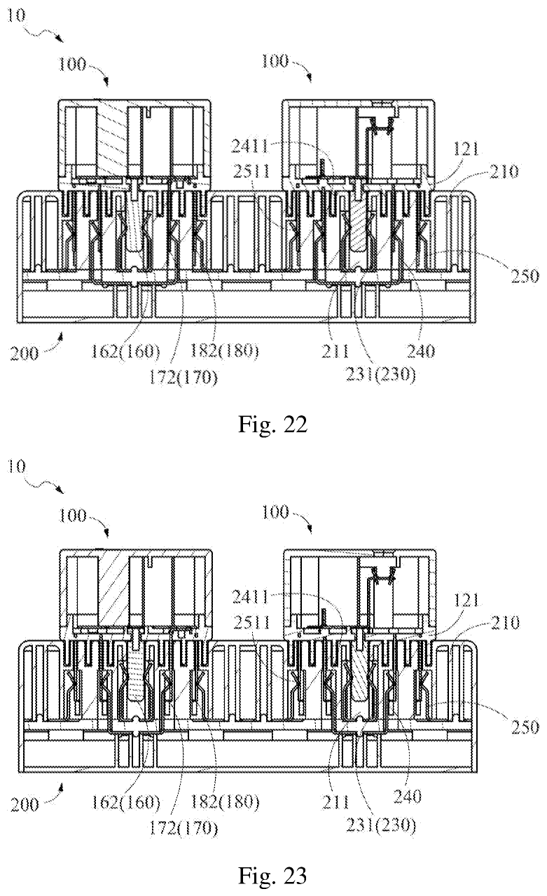

The conductor member is disposed between the upper insulating housing 310 and the lower insulating housing 320 and passes through the lower insulating housing 320. The conductor member includes a center conductor 330, an inner conductor 340 and an outer conductor 350. As shown in FIG. 22 and FIG. 23, the center conductor 330 has a center elastic piece portion 331, a center fixing portion 332 and a center docking portion 333. The center conductor 330 is fixed between the upper insulating housing 310 and the lower insulating housing 320, and the center connecting portion 333 is disposed correspondingly to the slot of the lower insulating housing 320. The inner conductor 340 has an inner elastic piece portion 341, an inner fixing portion 342 and an inner docking portion 343. The inner elastic piece portion 341 is arranged correspondingly to the socket 311 of the upper insulating shell 310, and the inner fixing portion 342 allows the inner conductor 340 to be fixed between the upper insulating housing 310 and the lower insulating housing 320. The internal docking portion 343 is disposed correspondingly to the slot of the lower insulating housing 320. The outer conductor 350 has an outer elastic piece portion 351, an outer fixing portion 352 and an outer docking portion 353. The outer elastic piece portion 351 is arranged correspondingly to the socket 311 of the upper insulating housing 310, and the outer fixing portion 352 allows the outer conductor 350 to be fixed between the upper insulating housing 310 and the lower insulating housing 320. The external docking portion 353 is disposed correspondingly to the slot of the lower insulating casing 320. The specifications of the conductor members and the manner of fixing the conductor members between the upper insulating housing 310 and the lower insulating housing 320 are not limited here.

The center docking portion 333 of the center conductor 330, the inner docking portion 343 of the inner conductor 340 and the outer docking portion 353 of the outer conductor 350 are sequentially disposed outside the lower insulating case 320 from inside to outside. In addition, the lower insulating housing 320 further comprises a first protruding portion 321 and a second protruding portion 322. The first protruding portion 321 is disposed between the center docking portion 333 of the center conductor 330 and the inner docking portion 343 of the inner conductor 340 to form the center docking slot 323. The second protruding portion 322 is disposed on the inner docking portion 343 of the inner conductor 340 and the outer docking portion 353 of the outer conductor 350 to form an inner docking slot 324.

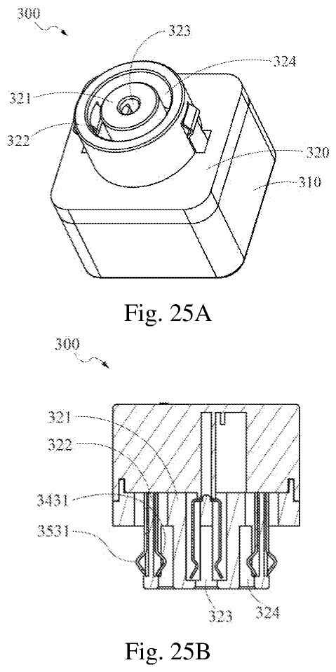

Please refer to FIGS. 25A and 25B. FIG. 25A is a three-dimensional view of the electrical connector 300 according to the fifth embodiment of the present disclosure. FIG. 25B is a cross-sectional view of FIG. 25A. Different from the electrical connector 300 shown in FIG. 24A, the bending direction of the inner contact surface 3431 of the inner conductor 340 of the electrical connector 300 shown in FIG. 25A is different.

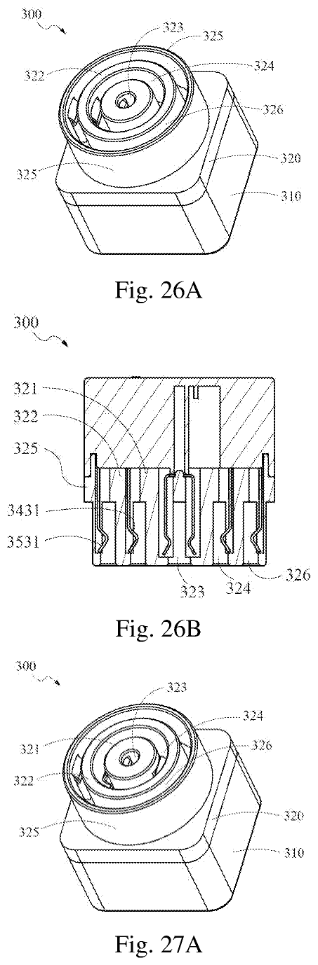

Please refer to FIGS. 26A and 26B. FIGS. 26A and 26B depict the electrical connector 300 according to a sixth embodiment of the present disclosure. Different from the embodiment shown in FIG. 24A, the lower insulating housing 320 further includes a third protruding portion 325 disposed outside the outer docking portion 353 of the outer conductor 350 to form an outer docking slot 326. The lower insulating housing 320 can protect the conductor member by the arrangement of the first protruding portion 321, the second protruding portion 322 and the third protruding portion 325, so that the front end of the docking portion of the conductor member does not receive excessive direct force and thus the electrical connector 300 could be repeatedly inserted and pulled out without causing the conductor member to be damaged. Specifically, only the elastic sheet-shaped portion of the conductor member is exposed in the slot of the lower insulating housing 320. If the center conductor 330 is the center and the elastic sheet-shaped portion is exposed in the direction away from the center conductor 330, the contact surface is regarded as facing toward the center conductor 330. On the contrary, if elastic sheet-shaped portion is exposed toward the direction close to the center conductor 330, the contact surface is regarded as facing inward. In more detail, the central docking portion 333, the inner docking portion 343 and the outer docking portion 353 respectively have a central contact surface 3331, an inner contact surface 3431 and an outer contact surface 3531. The central contact surface 3331 is exposed in the central docking slot 323. The inner contact surface 3431 is exposed in the inner docking slot 324. The outer contact surface 3531 is exposed in the outer docking slot 326.

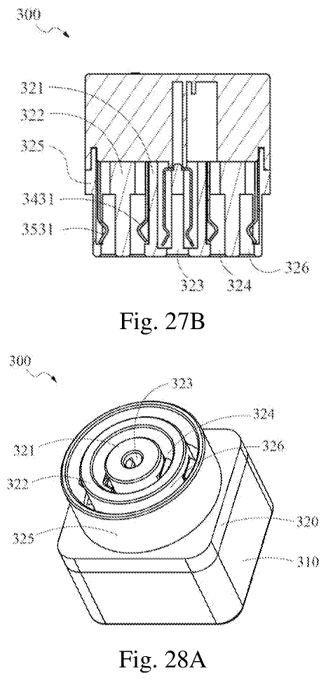

Please refer to FIGS. 27A and 27B. FIG. 27A is a three-dimensional view of the electrical connector 300 according to a seventh embodiment of the present disclosure. FIG. 27B is a cross-sectional view of FIG. 27A. Different from the electrical connector 300 shown in FIG. 26A, the bending direction of the inner contact surface 3431 of the inner conductor 340 of the electrical connector 300 shown in FIG. 27A is outward (away from the center conductor 330).

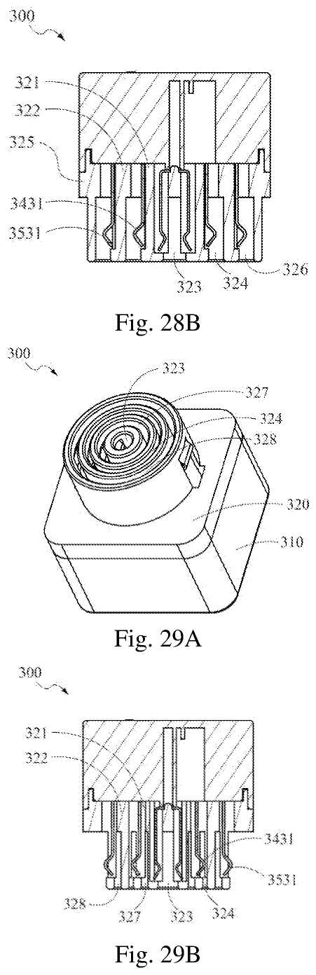

Please refer to FIGS. 28A and 28B. FIG. 28A is a three-dimensional view of the electrical connector 300 according to an eighth embodiment of the present disclosure. FIG. 28B is a cross-sectional view of FIG. 28A. Different from the electrical connector 300 shown in FIG. 26A, the inner contact surface 3431 of the inner conductor 340 and the outer contact surface 3531 of the outer docking portion 353 of the electrical connector 300 shown in FIG. 28A are both bent outwards (away from the center conductor 330).

Please refer to FIGS. 29A and 29B. FIG. 29A is a three-dimensional view of the electrical connector 300 according to a ninth embodiment of the present disclosure. FIG. 29B is a cross-sectional view of FIG. 29A. Different from the electrical connector 300 shown in FIG. 26A, the bending direction of the outer contact surface 3531 of the outer docking portion 353 of the electrical connector 300 shown in FIG. 29A is outward (away from the center conductor 330).

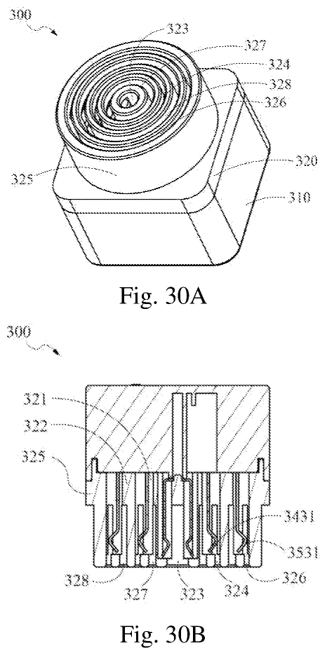

Please refer to FIGS. 30A and 30B. FIG. 30A is a three-dimensional view of the electrical connector 300 according to the tenth embodiment of the present disclosure. FIG. 30B is a cross-sectional view of FIG. 30A. The lower insulating housing 320 comprises a first protruding portion 321 and a second protruding portion 322 and thus comprises a central docking slot 323 and an inner docking slot 324. In addition, the lower insulating shell 320 further comprises an inner receiving groove 327 disposed on the first protruding portion 321 and an outer receiving groove 328 disposed on the second protruding portion 322. The inner contact surface 3431 and the outer contact surface 3531 both face outward.

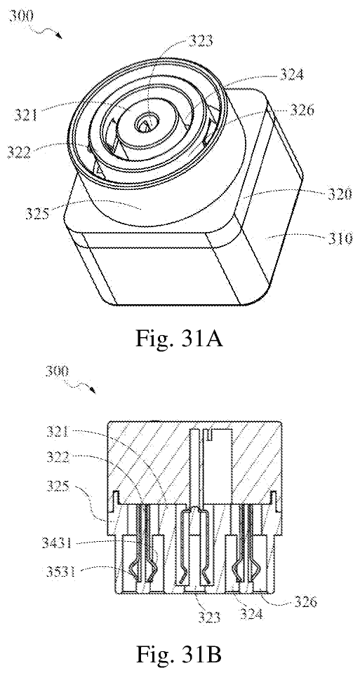

Please refer to FIGS. 31A and 31B. FIG. 31A is a three-dimensional view of the electrical connector 300 according to the eleventh embodiment of the present disclosure. FIG. 31B is a cross-sectional view of FIG. 31A. The lower insulating housing 320 comprises a first protruding portion 321, a second protruding portion 322 and a third protruding portion 325 and thus comprises a center docking slot 323, an inner docking slot 324 and an outer docking slot 326. Additionally, the inner contact surface 3431 faces inward and the outer contact surface 3531 faces outward.

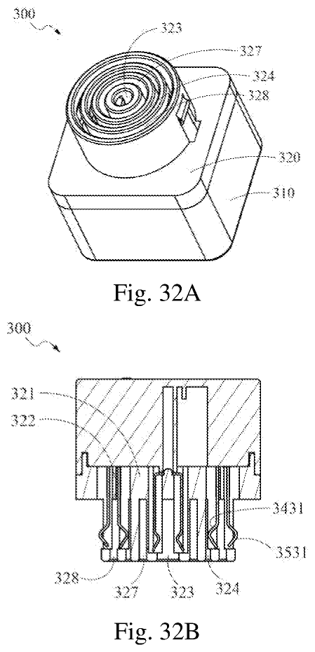

Please refer to FIGS. 32A and 32B. FIG. 32A is a three-dimensional view of the electrical connector 300 according to the twelfth embodiment of the present disclosure. FIG. 32B is a cross-sectional view of FIG. 32A. The lower insulating housing 320 comprises a center docking slot 323 and an inner docking slot 324, and further comprises an inner receiving slot 327 disposed on the first protruding portion 321 and an outer receiving groove 328 disposed on the second protruding portion 322. The inner contact surface 3431 faces inward, and the outer contact surface 3531 faces outward.

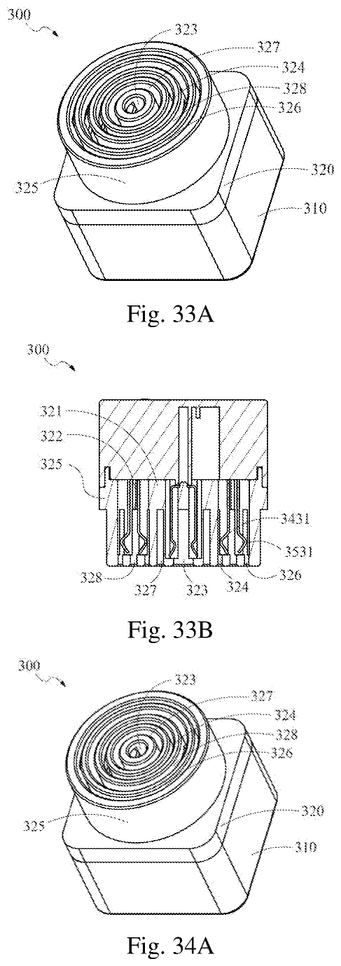

Please refer to FIGS. 33A and 33B. FIG. 33A is a three-dimensional view of the electrical connector 300 according to the thirteenth embodiment of the present disclosure. FIG. 33B is a cross-sectional view of FIG. 33A. The difference in the embodiment shown in FIG. 33A is that the lower insulating shell 320 further comprises a third protruding portion 325, and thus has an external docking slot 326. In addition, the lower insulating housing 320 further comprises an inner receiving groove 327 disposed on the first protruding portion 321 and an outer receiving groove 328 disposed on the second protruding portion 322. The inner contact surface 3431 faces inward, and the outer contact surface 3531 faces outward.

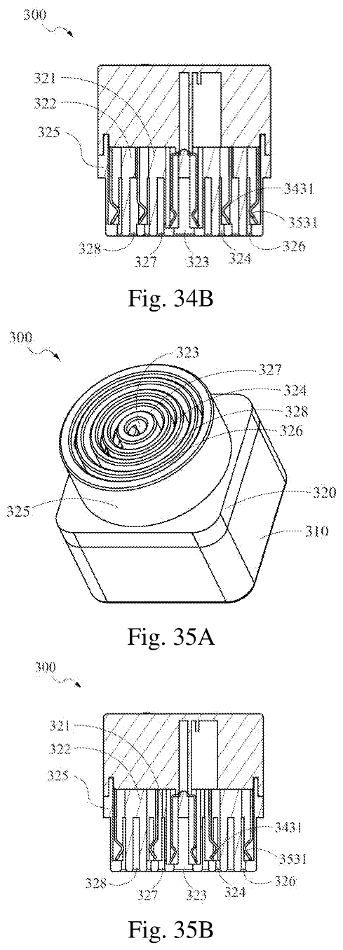

Please refer to FIGS. 34A and 34B. FIG. 34A is a three-dimensional view of the electrical connector 300 according to the fourteenth embodiment of the present disclosure. FIG. 34B is a cross-sectional view of FIG. 34A. Here, the lower insulating housing 320 comprises a central docking slot 323 and an inner docking slot 324, and the inner contact surface 3431 and the outer contact surface 3531 both face inward.

Please refer to FIGS. 35A and 35B. FIG. 35A is a three-dimensional view of the electrical connector 300 according to the fifteenth embodiment of the present disclosure. FIG. 35B is a cross-sectional view of FIG. 35A. Here, the lower insulating housing 320 further comprises an inner receiving groove 327 disposed on the first protruding portion 321 and an outer receiving groove 328 disposed on the second protruding portion 322. The inner contact surface 3431 faces outward, and the outer contact surface 3531 faces inward.

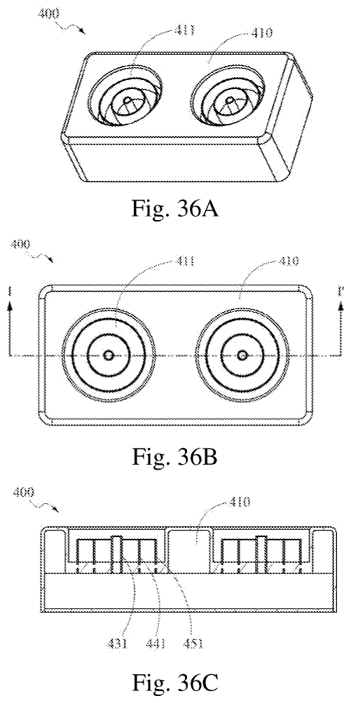

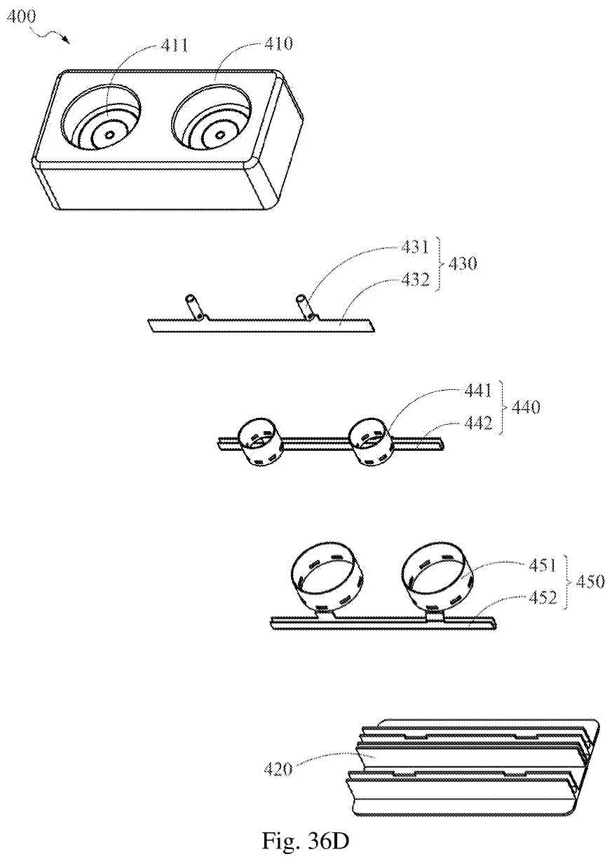

Please refer to FIGS. 36A-36D. FIG. 36A is a three-dimensional view of the base 400 according to the ninth embodiment of the present disclosure. FIG. 36B is a top view of FIG. 36A. FIG. 36C is a cross-sectional view taken along line I-f of FIG. 36B. FIG. 36D is an exploded view of the base 400 according to the ninth embodiment of the present disclosure. The base 400 includes a third insulating housing 410, a fourth insulating housing 420 and a conductor member. The third insulating housing 410 has at least one socket 411. The fourth insulating housing 420 is disposed under the third insulating housing 410 and is connected with the third insulating housing 410 to form a cavity for accommodating the conductor members. In this embodiment, the base 400 has two sets of sockets 411, but it is not limited thereto. In some embodiments, the number and the actual arrangement of the sockets 411 can be adjusted according to the circuit layout.

The conductor member is disposed between the third insulating housing 410 and the fourth insulating housing 420 and includes a first conductor 430, a second conductor 440 and a third conductor 450. The first conductor 430 has a first contact portion 431 and a first fixing portion 432. The first contact portion 431 is disposed correspondingly to a socket 411 of the third insulating housing 410. The first fixing portion 432 allows the first conductor 430 to be fixed between the third insulating housing 410 and the fourth insulating housing 420. The second conductor 440 has a second contact portion 441 and a second fixing portion 442. The second contact portion 441 is disposed correspondingly to a socket 411 of the third insulating housing 410. The second fixing portion 442 allows the second conductor 440 to be fixed between the third insulating housings 410 and the fourth insulating housing 420. The third conductor 450 has a third contact portion 451 and a third fixing portion 452. The third contact portion 451 is disposed correspondingly to a socket 411 of the third insulating housing 410. The third fixing portion 452 allows the third conductor 450 to be fixed between the third insulating housings 410 and the fourth insulating housing 420. The first contact portion 431 of the first conductor 430, the second contact portion 441 of the second conductor 440, and the third contact portion 452 of the third conductor 450 are sequentially disposed on the third insulating housing 410 from inside to outside. The specifications of the conductor members and the manner of fixing the conductor member between the third insulating case 410 and the fourth insulating case 420 are not limited here.

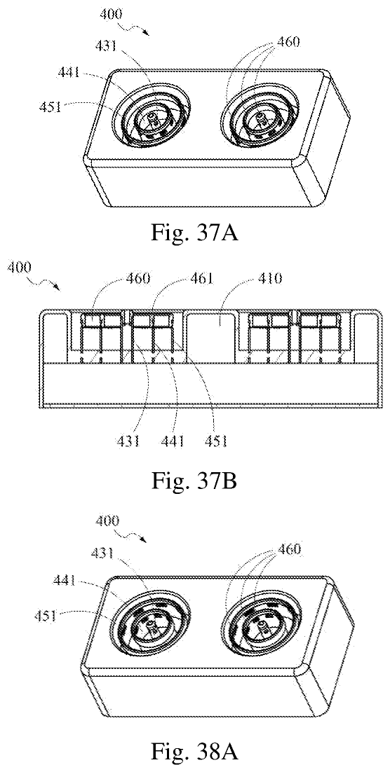

Please refer to FIGS. 37A and 37B. FIG. 37A is a three-dimensional view of the base 400 according to the tenth embodiment of the present disclosure. FIG. 37B is a cross-sectional view of FIG. 37A. The base 400 further comprises a protective cover 460 disposed on the front edge of the first contact portion 431 of the first conductor 430, the front edge of the second contact portion 441 of the second conductor 440 and the front edge of the third contact portion 451 of the third conductor 450. By disposing the protective cover 460 on the front edges of the contact portions, the danger of electric shock caused by the user touching the electrified contact portions can be avoided, so as to increase the safety of use. In this embodiment, the snap-fit end 461 of the protective cover 460 is snapped on the inner sides of the second contact portion 441 and the third contact portion 451.

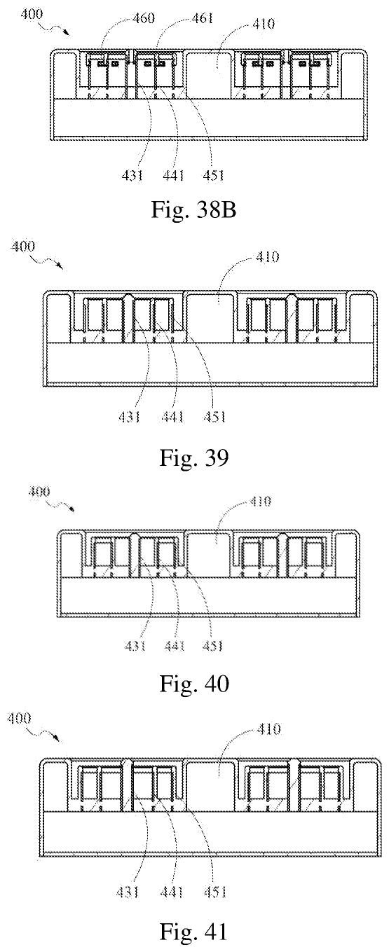

Please refer to FIGS. 38A and 38B. FIG. 38A is a three-dimensional view of the base 400 according to the eleventh embodiment of the present disclosure. FIG. 38B is a cross-sectional view of FIG. 38A. The difference from the embodiment shown in FIG. 37A is that the snap-fit end 461 of the protective cover 460 in FIG. 38A is snapped on the outside of the second contact portion 441 and the third contact portion 451.

Please refer to FIG. 39, which is a cross-sectional view of the base 400 according to the twelfth embodiment of the present disclosure. The third insulating housing 410 has an extension portion 412 that contacts the first contact portion 431 of the first conductor 430, the second contact portion 441 of the second conductor 440 and the third contact portion 451 of the third conductor 450. The extension portion 412 is disposed at a position corresponding to the socket 411 to cover the first contact portion 431, the second contact portion 441 and the third contact portion 451. In more detail, the extension portion 412 is extended to the front edge of the first contact portion 431, the front edge of the second contact portion 441 and the front edge of the third contact portion 451. The contact surfaces of the second contact portion 441 and the third contact portion 451 both face outward. By extending the insulating material to cover the conductor member, it is possible to prevent fingers from directly touching the contact portion of the conductor member, thereby improving the safety.

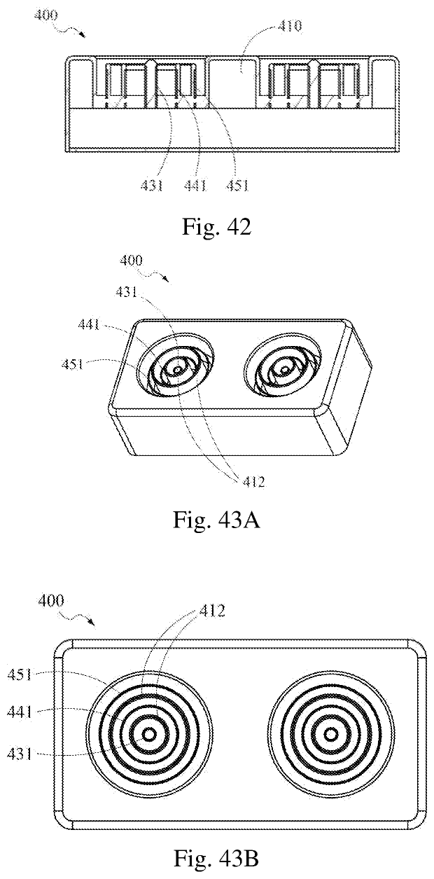

Please refer to FIGS. 39-42. FIG. 40 is a cross-sectional view of the base 400 according to the thirteenth embodiment of the present disclosure. FIG. 41 is a cross-sectional view of the base 400 according to the fourteenth embodiment of the present disclosure. FIG. 42 is a cross-sectional view of the base 400 according to the fifteenth embodiment of the present disclosure. Different from FIG. 39, in the embodiment shown in FIG. 40, the contact surface of the second contact portion 441 faces outward, and the contact surface of the third contact portion 451 faces inward. In the embodiment shown in FIG. 41, the contact surfaces of the second contact portion 441 and the third contact portion 451 both face inward. In the embodiment shown in FIG. 42, the contact surface of the second contact portion 441 faces inward, and the contact surface of the third contact portion 451 faces outward.

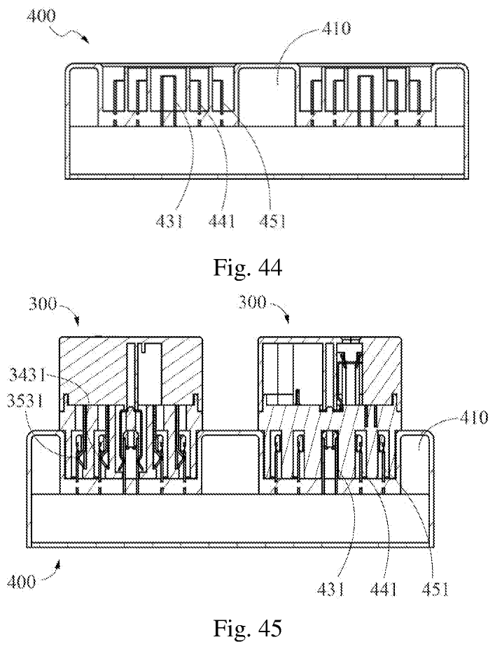

Please refer to FIGS. 43A-43B and FIG. 44. FIG. 43A is a three-dimensional view of the base 400 according to the sixteenth embodiment of the present disclosure. FIG. 43B is a top view of FIG. 43A. FIG. 44 is a cross-sectional view of FIG. 43B. The extension portion 412 could be disposed not only on the front edge of the first contact portion 431, the front edge of the second contact portion 441 and the front edge of the third contact portion 451, but also between the first contact portion 431 of the first conductor 430 and the third contact portion 451 of the third conductor 450. By extending the insulating material, it is possible to prevent fingers from directly touching the contact portion.

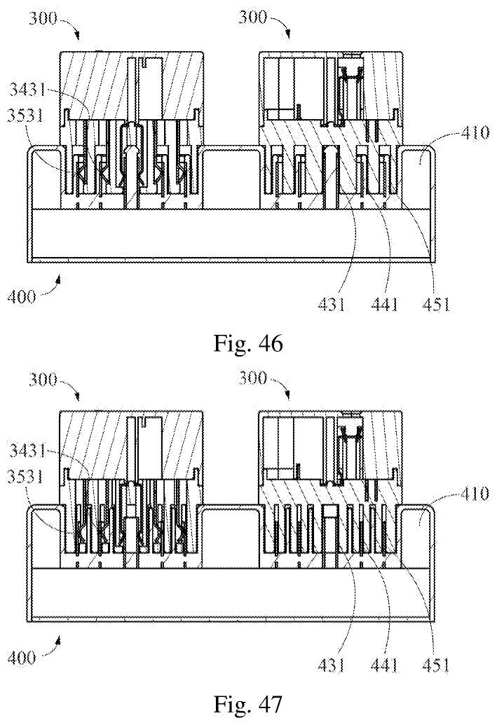

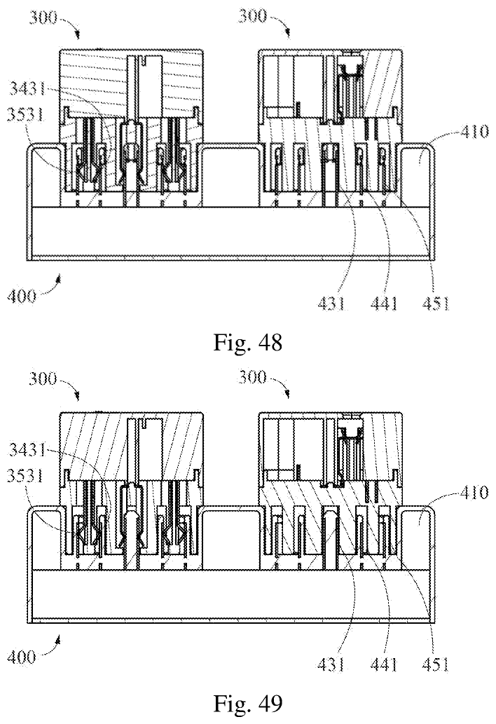

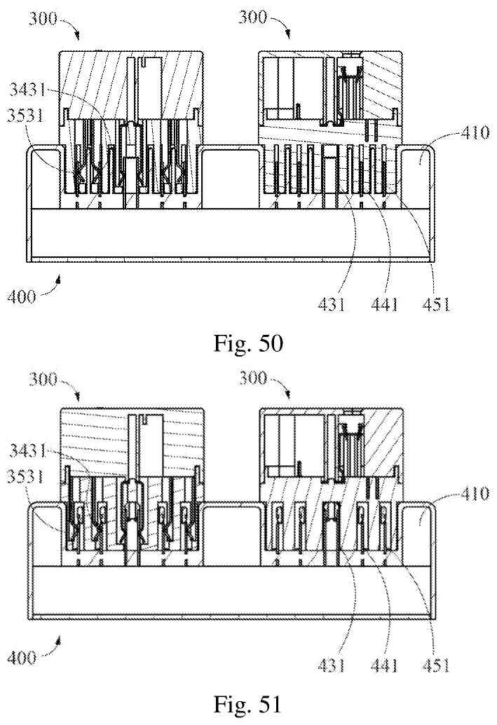

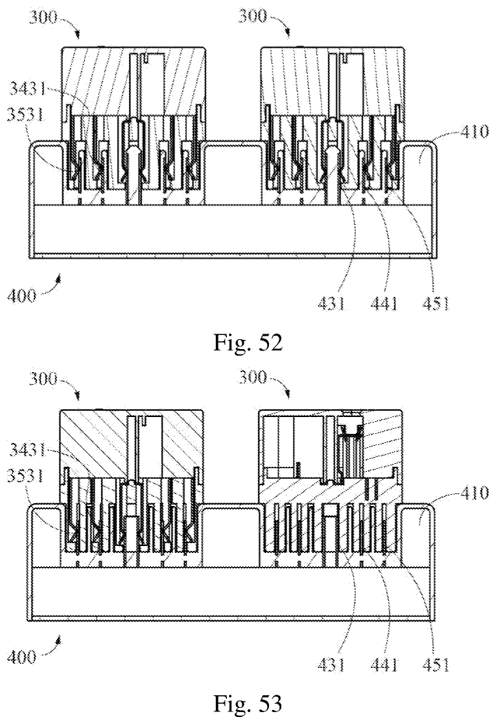

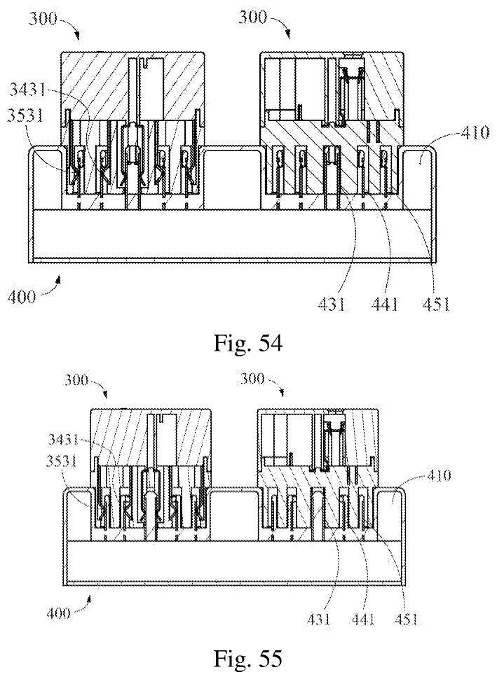

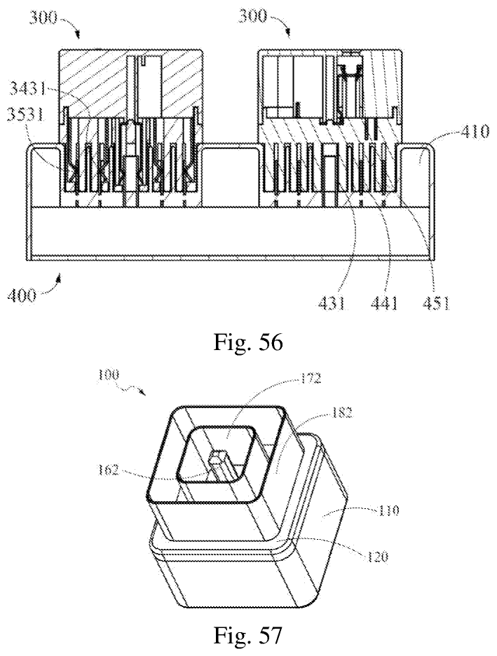

Please refer to FIGS. 45-56. FIG. 45 is a cross-sectional view of the electrical connector of FIG. 28B and the base of FIG. 37A after being assembled. FIG. 46 is a cross-sectional view of the electrical connector of FIG. 28B and the base of FIG. 41 after being assembled. FIG. 47 is a cross-sectional view of the electrical connector of FIG. 30A and the base of FIG. 43A after being assembled. FIG. 48 is a cross-sectional view of the electrical connector of FIG. 31A and the base of FIG. 37A after being assembled. FIG. 49 is a cross-sectional view of the electrical connector of FIG. 31A and the base of FIG. 40 after being assembled. FIG. 50 is a cross-sectional view of the electrical connector of FIG. 33A and the base of FIG. 43A after being assembled. FIG. 51 is a cross-sectional view of the electrical connector of FIG. 26A and the base of FIG. 37A after being assembled. FIG. 52 is a cross-sectional view of the electrical connector of FIG. 26A and the base of FIG. 39 after being assembled. FIG. 53 is a cross-sectional view of the electrical connector of FIG. 34A and the base of FIG. 43A after being assembled. FIG. 54 is a cross-sectional view of the electrical connector of FIG. 27A and the base of FIG. 37A after being assembled. FIG. 55 is a cross-sectional view of the electrical connector of FIG. 27A and the base of FIG. 42 after being assembled. FIG. 56 is a cross-sectional view of the electrical connector of FIG. 35A and the base of FIG. 43A after being assembled.

The electrical connector assembly comprises at least one aforementioned electrical connector 300 and one aforementioned base 400. When the at least one connector 300 is assembled with the base 400, the central docking portion 333 of the central conductor 330 passes through the socket 411 of the third insulating housing 410 and is electrically connected to the first contact portion 431. At the same time, the inner docking portion 343 of the inner conductor 340 passes through the socket 411 of the third insulating housing 410 and is electrically connected to the second contact portion 441. The outer docking portion 353 of the outer conductor 350 passes through the socket 411 in the third insulating housing 410 and is electrically connected to the third contact portion 451. In order to electrically connect the conductor member disposed in the base 400 to the docked electrical connector 300, the contact surface of the contact portion is exposed to the socket 411 of the third insulating housing 410 to directly contact the docking portion of the electrical connector 300 such that an electrical connection could be established.

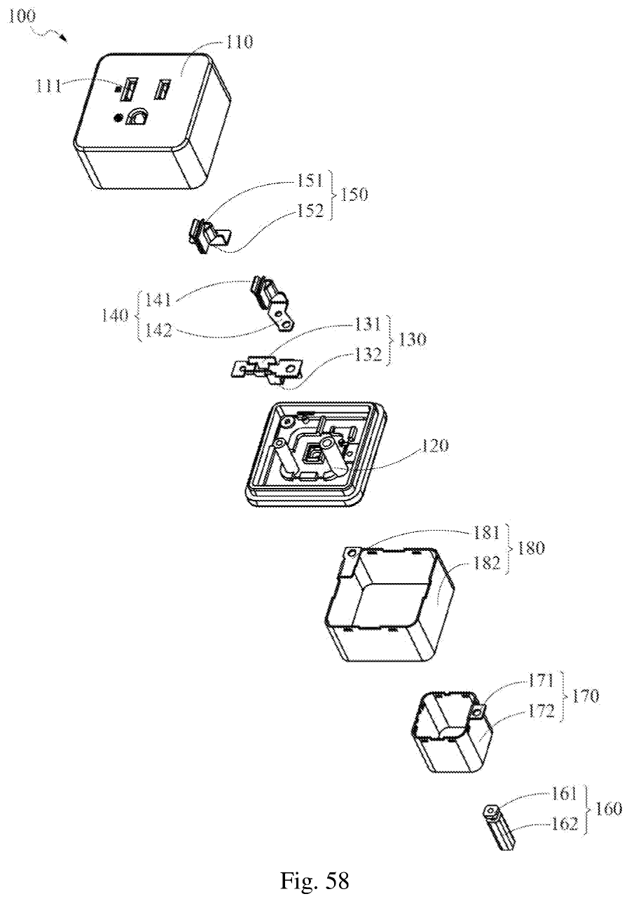

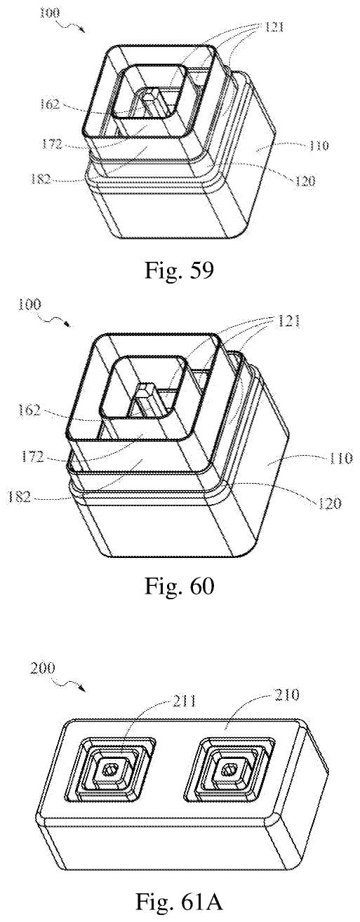

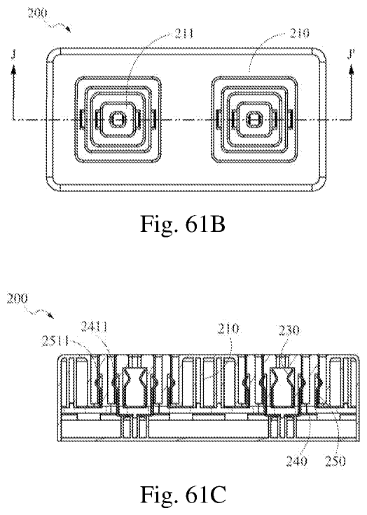

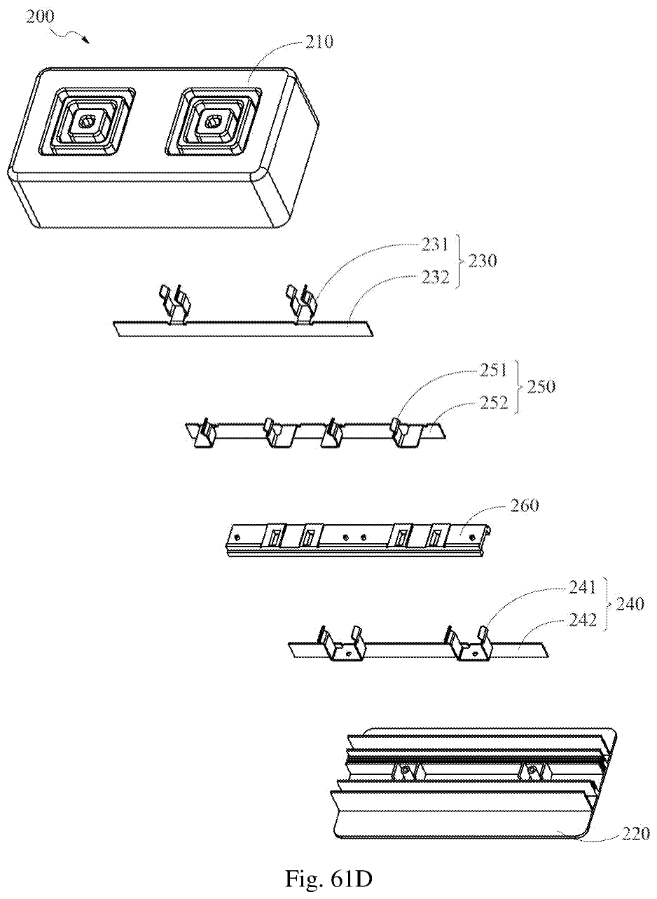

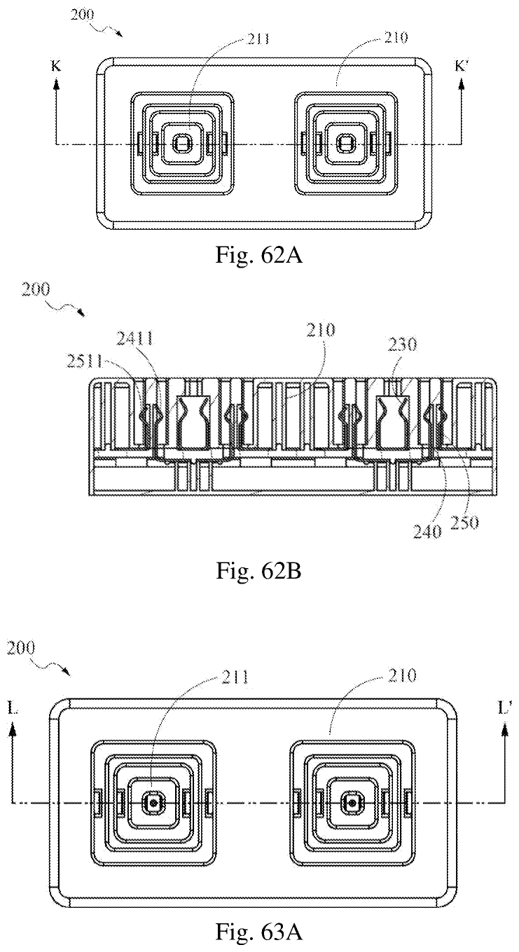

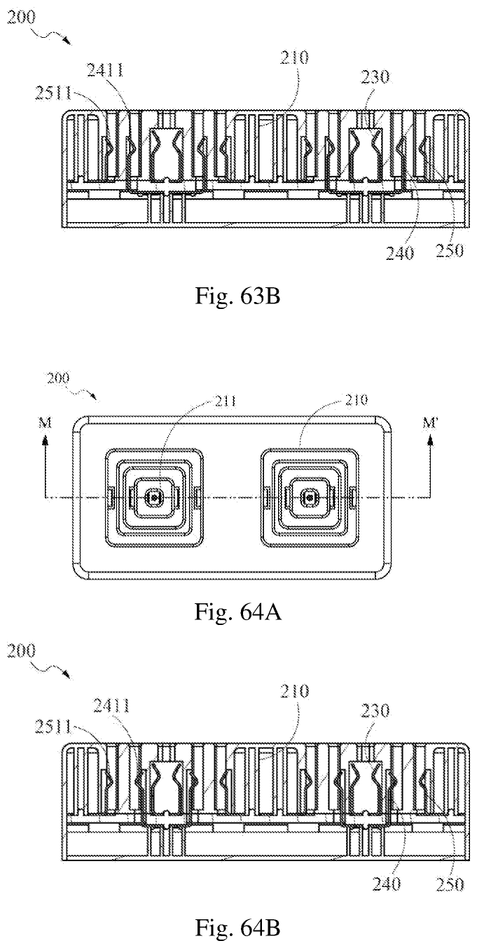

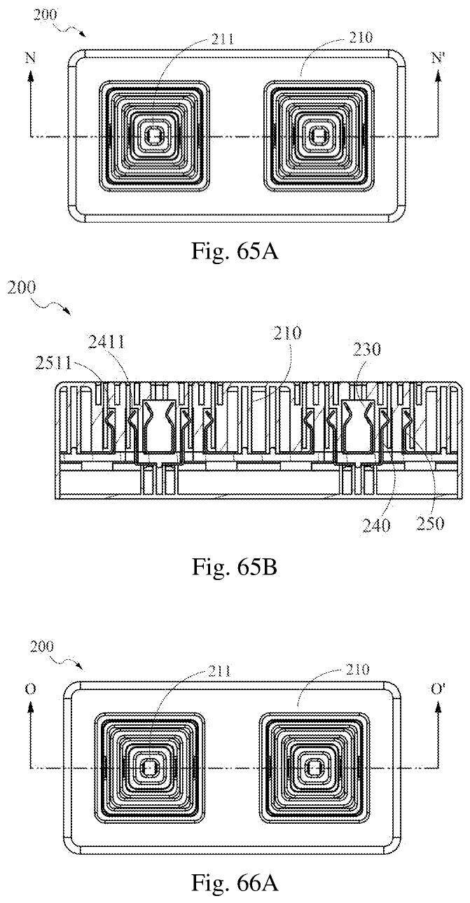

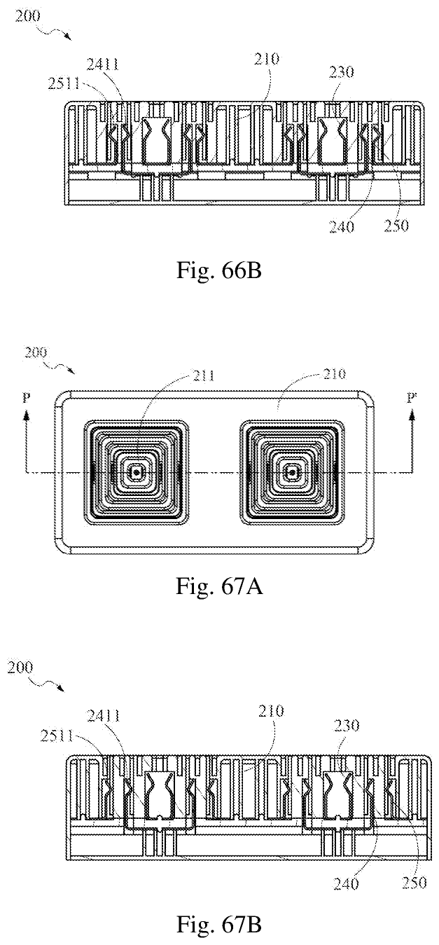

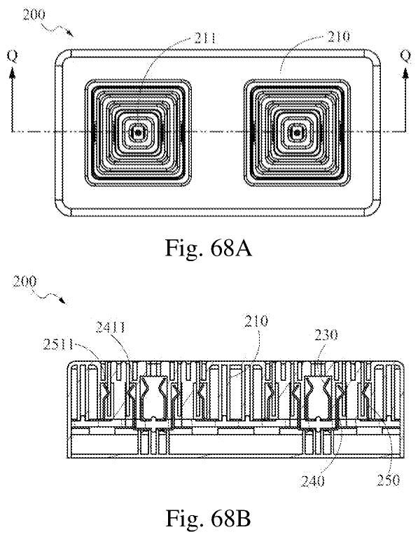

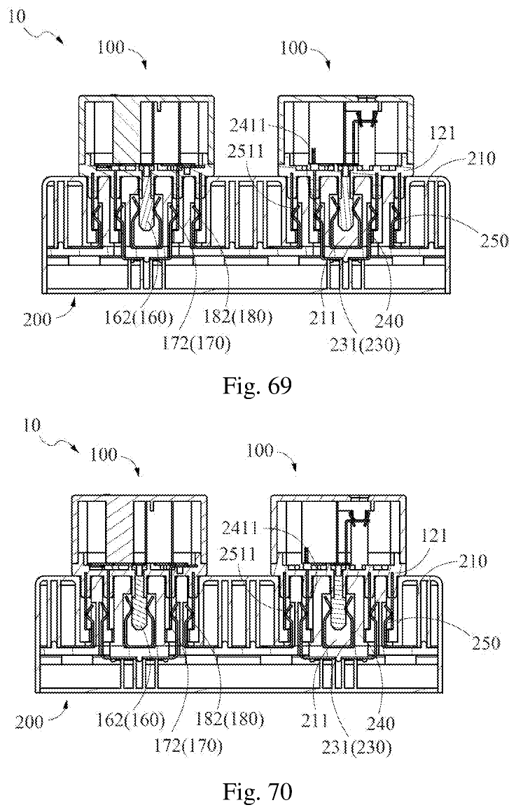

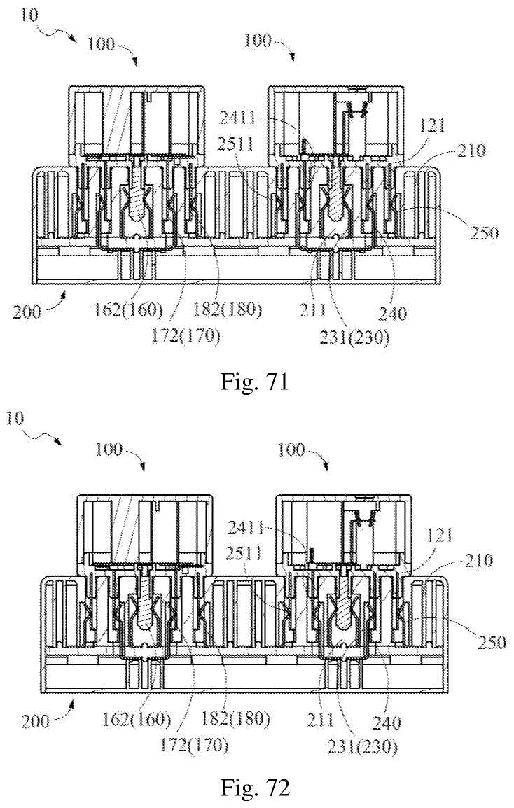

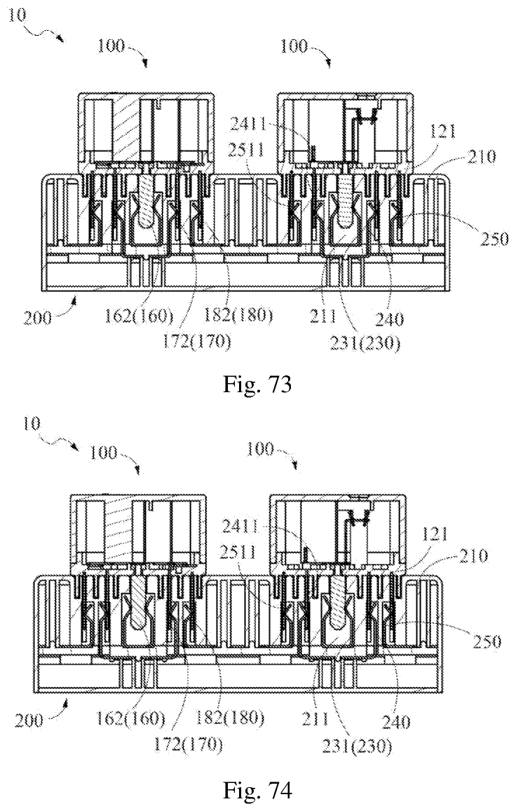

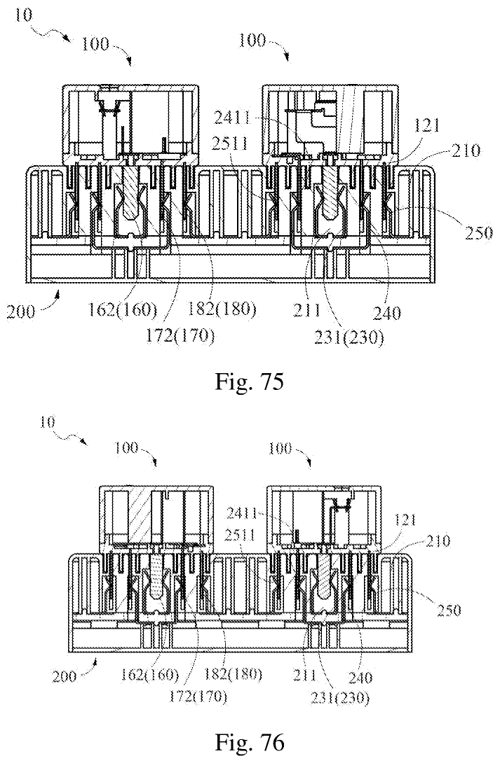

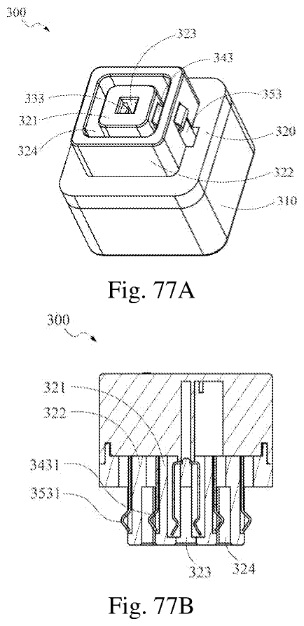

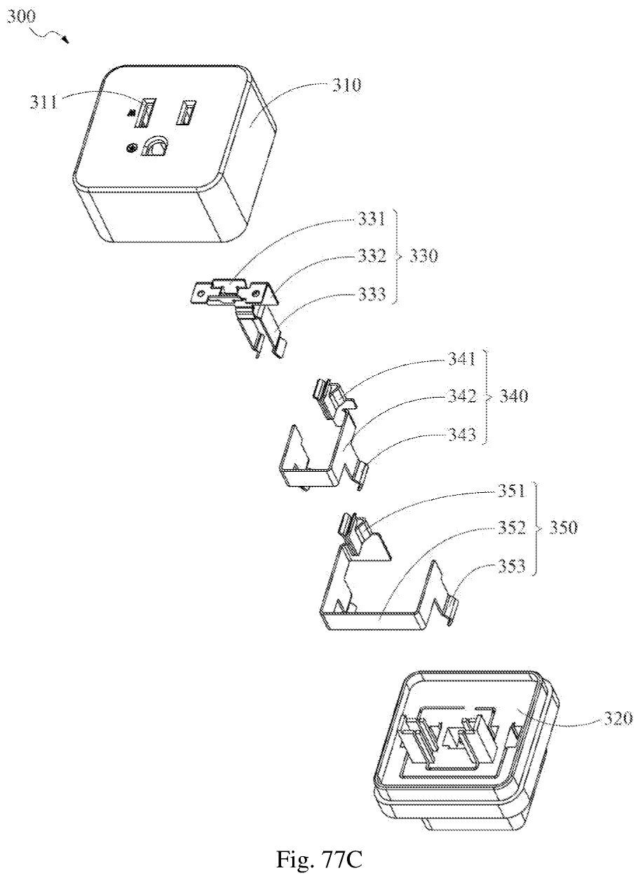

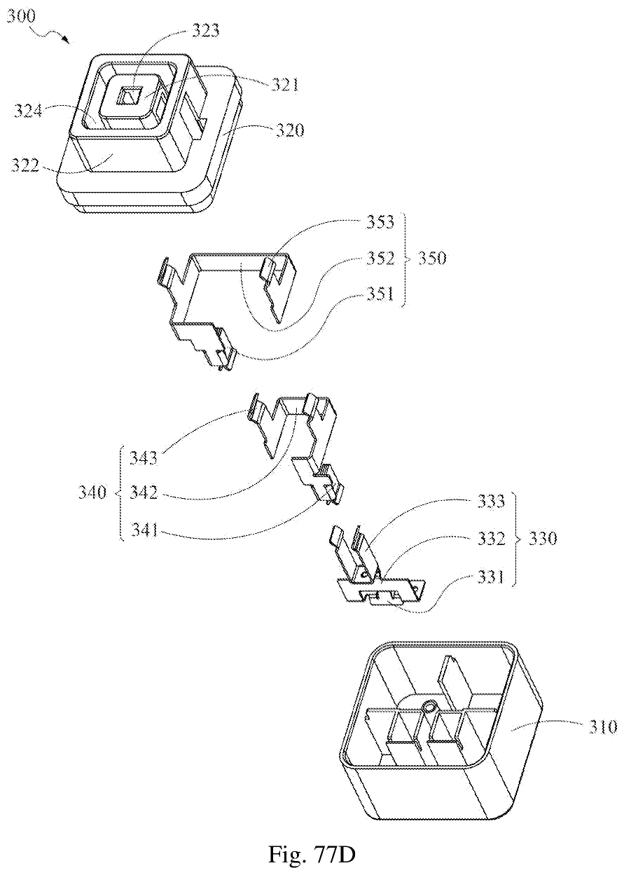

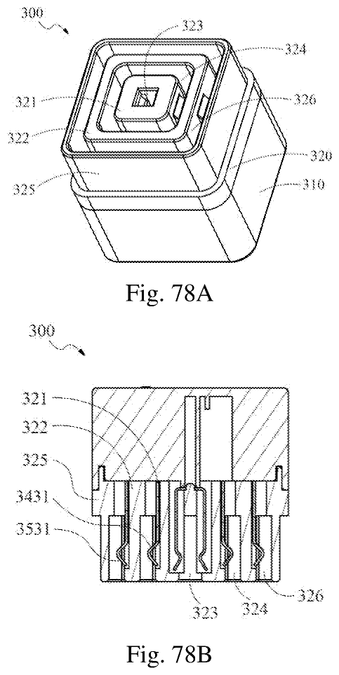

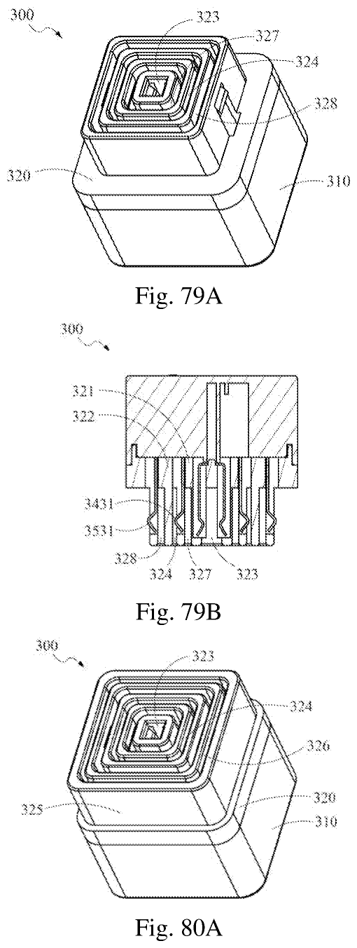

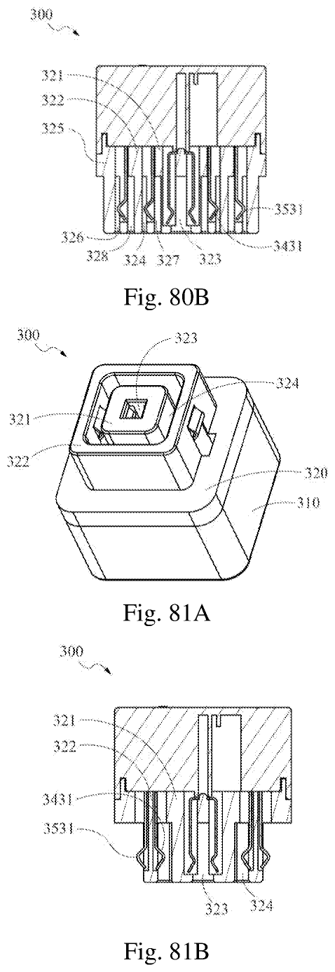

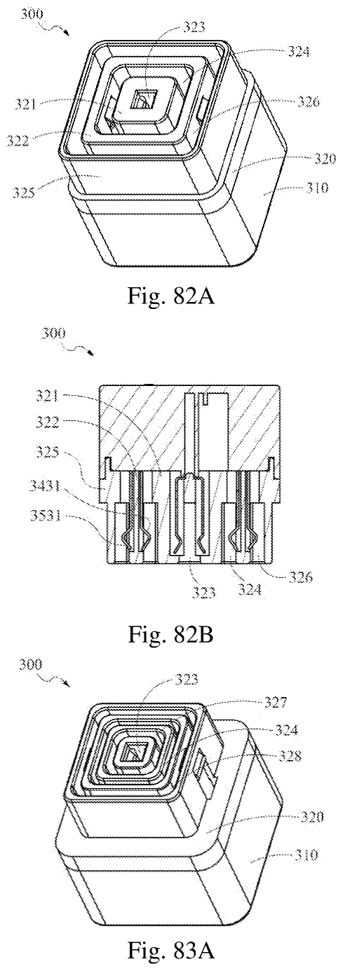

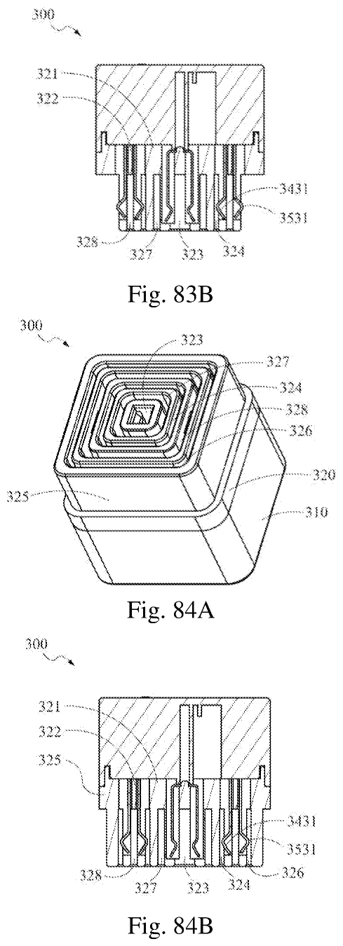

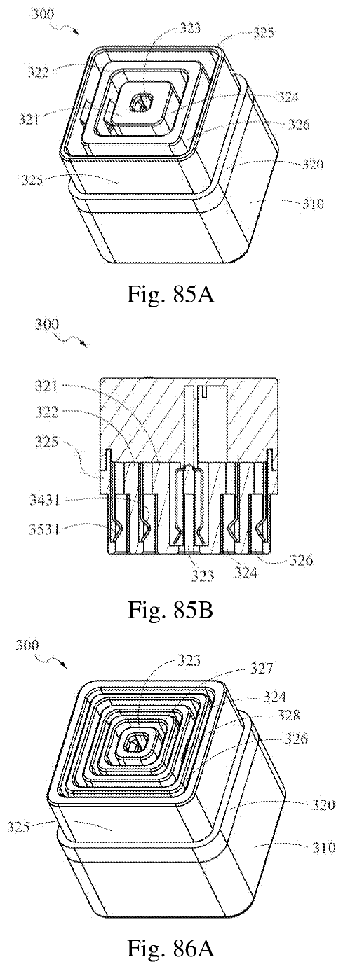

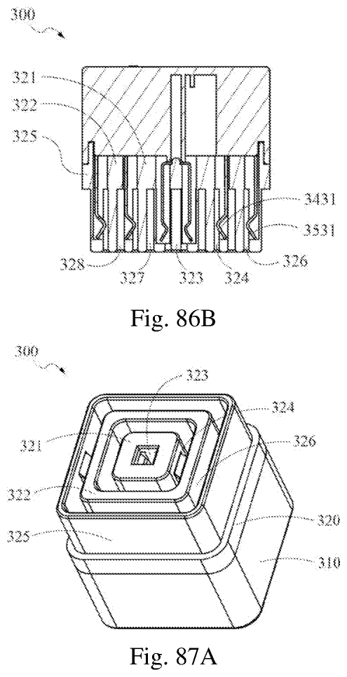

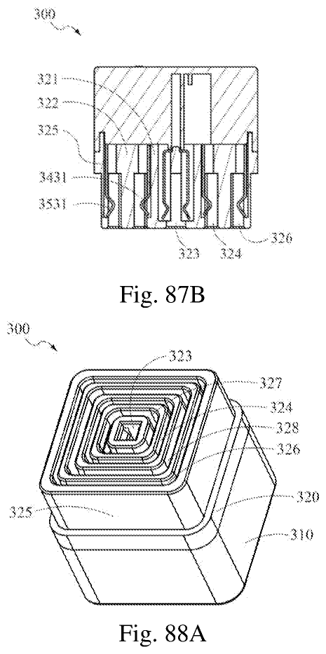

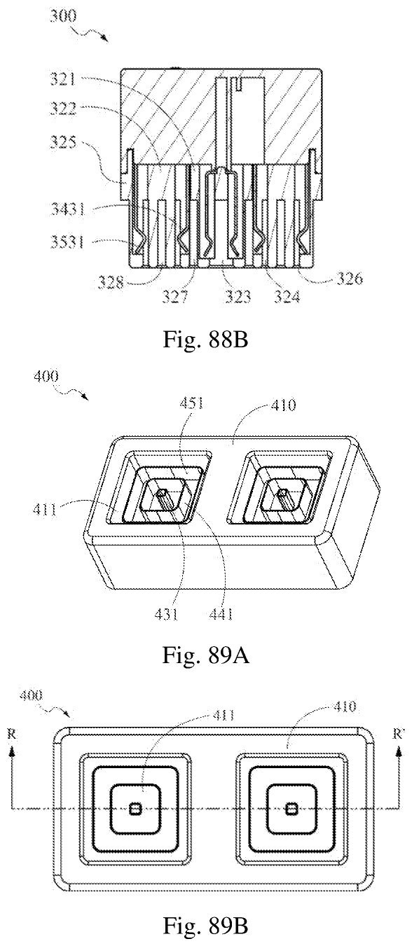

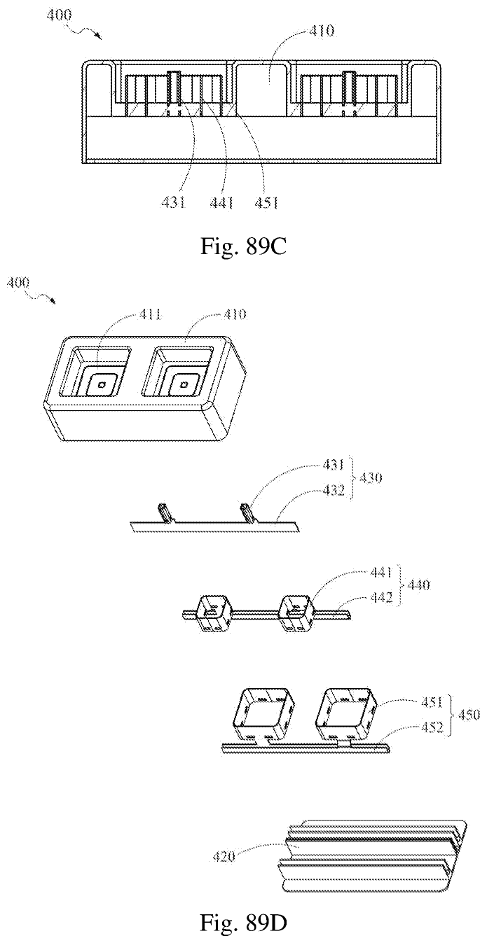

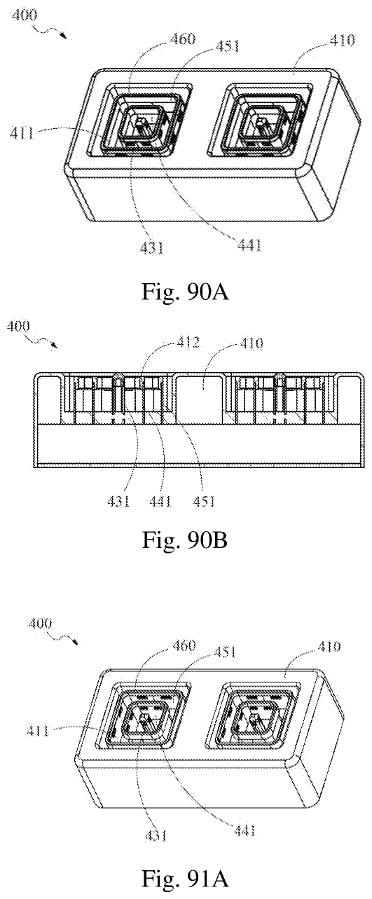

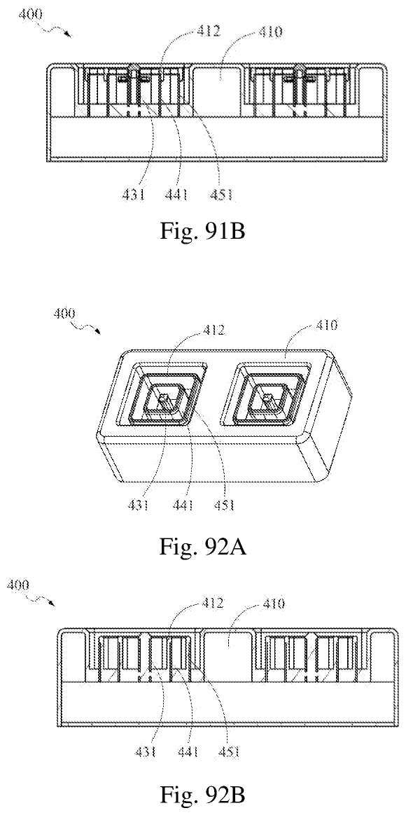

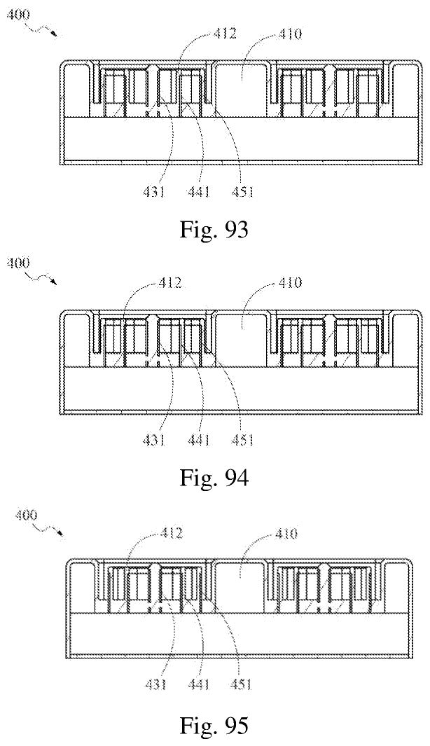

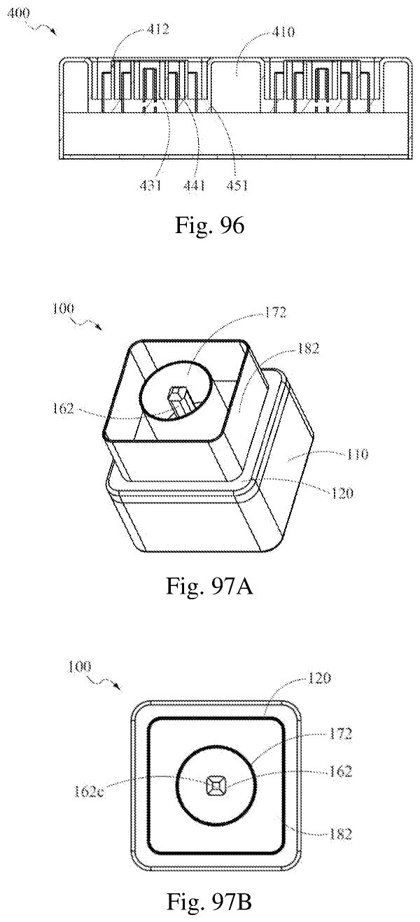

Please refers to FIGS. 57-96. Different from the shape of the electrical connector, the base and the electrical connector assembly disclosed in the embodiments of FIGS. 1-56 is circular, the electrical connector, the base and the electrical connector assembly disclosed in the embodiments of FIGS. 57-96 are in a square shape but the other structures shown in FIGS. 57-96 are basically similar.

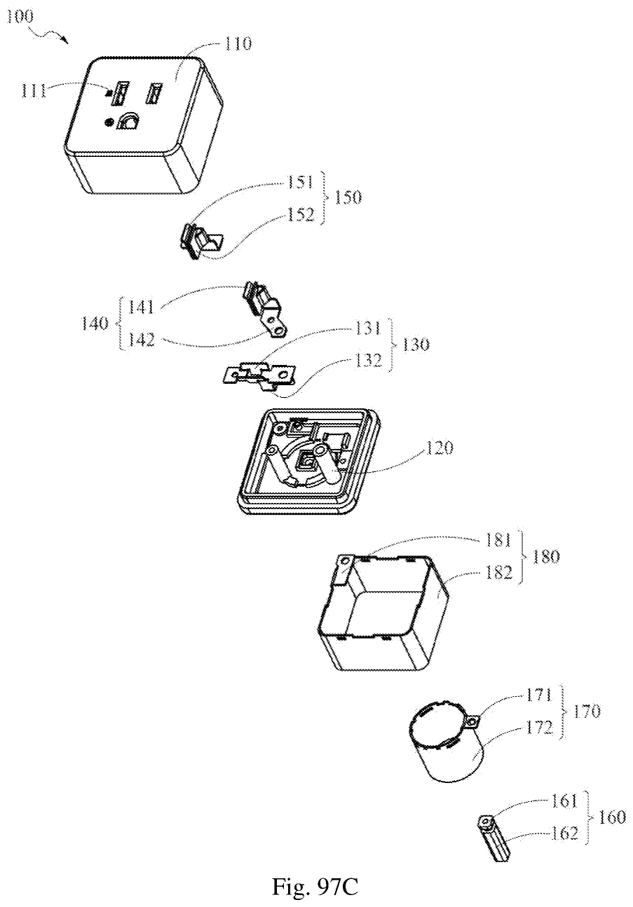

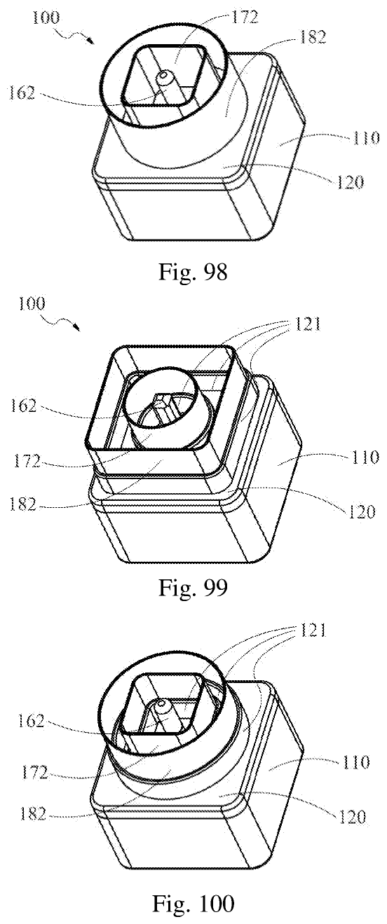

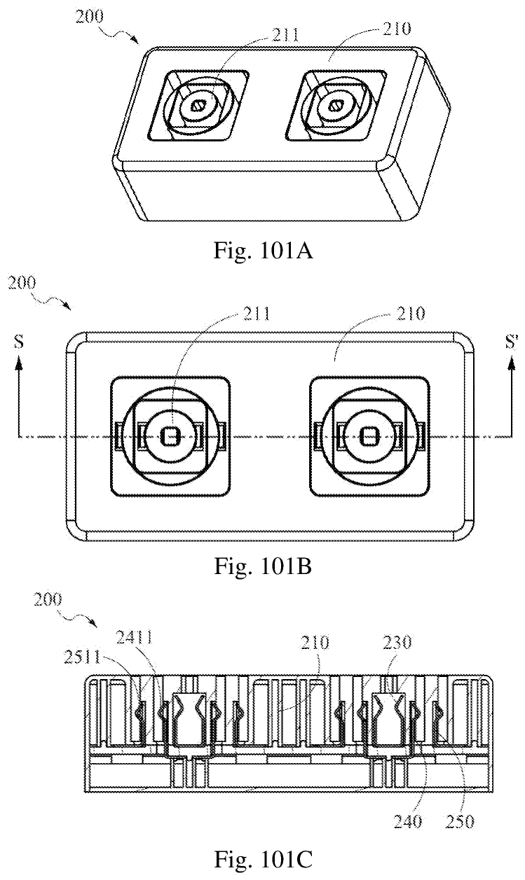

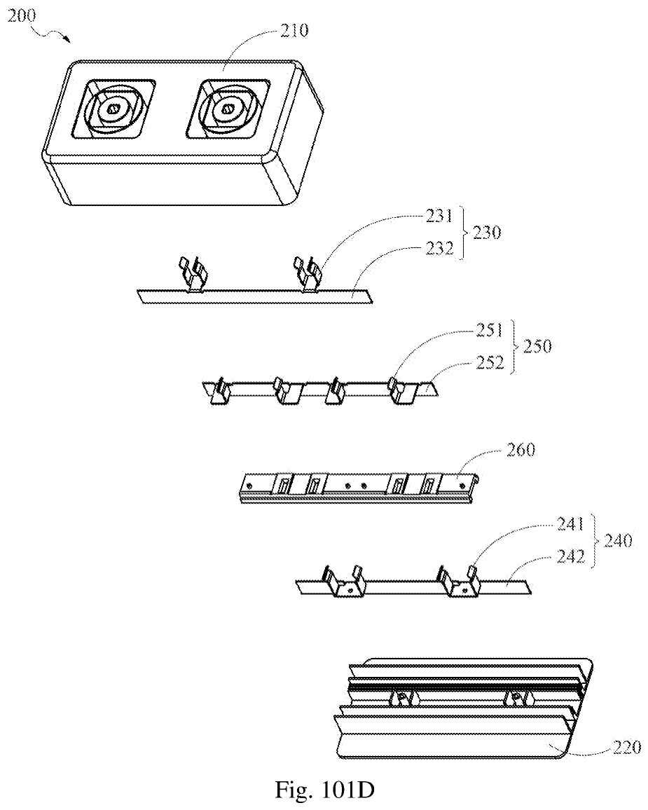

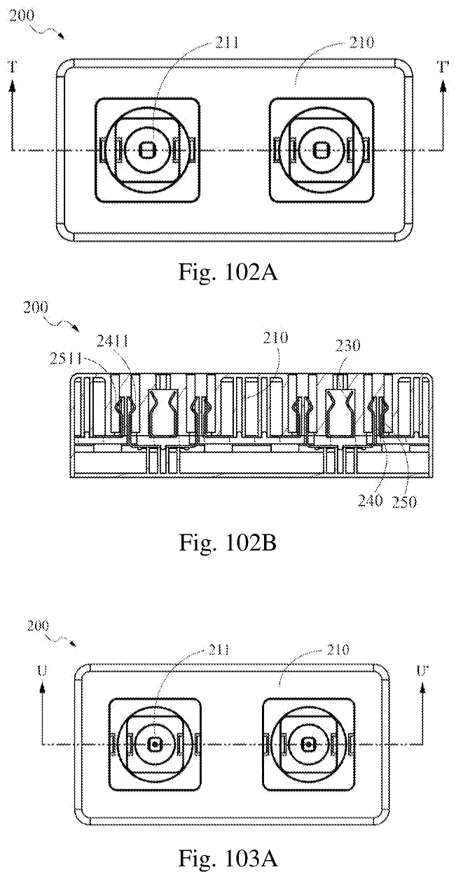

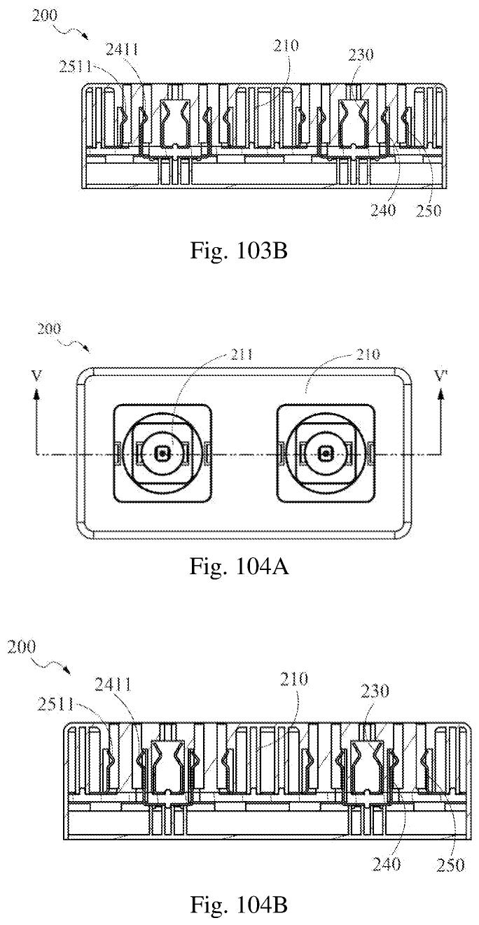

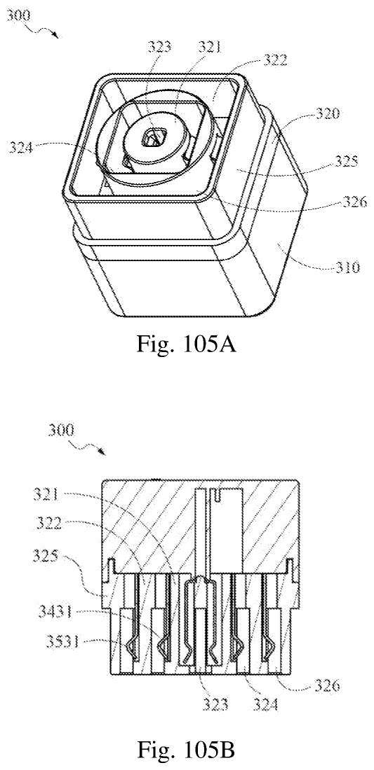

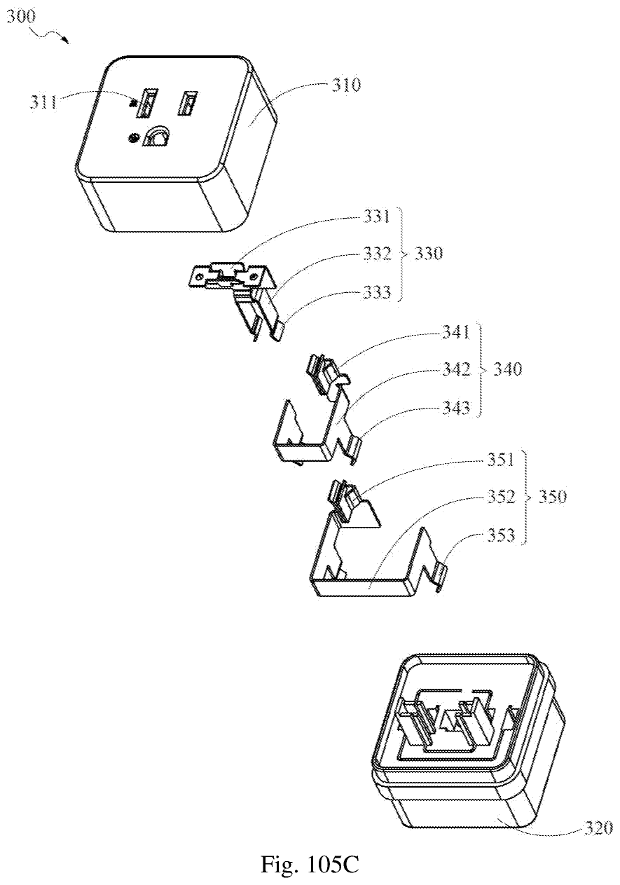

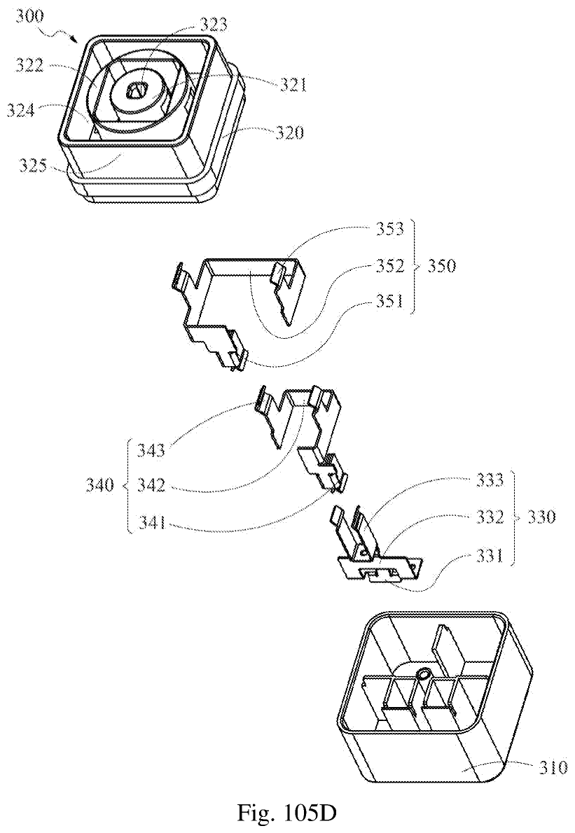

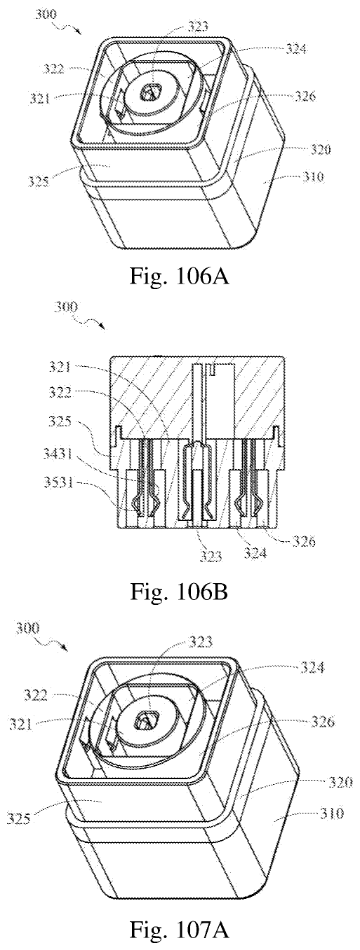

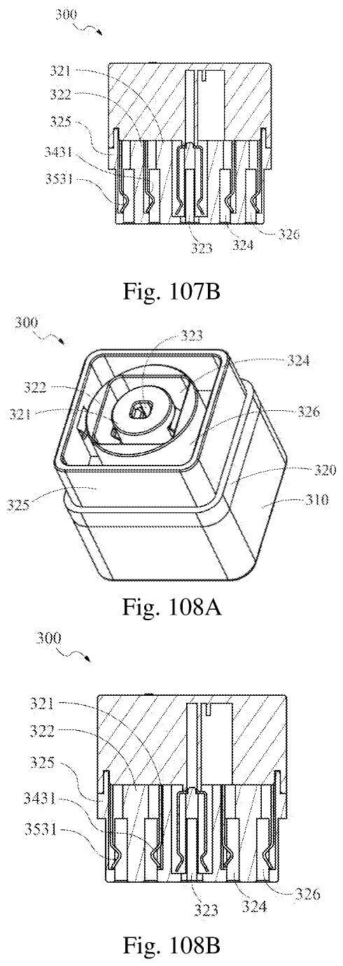

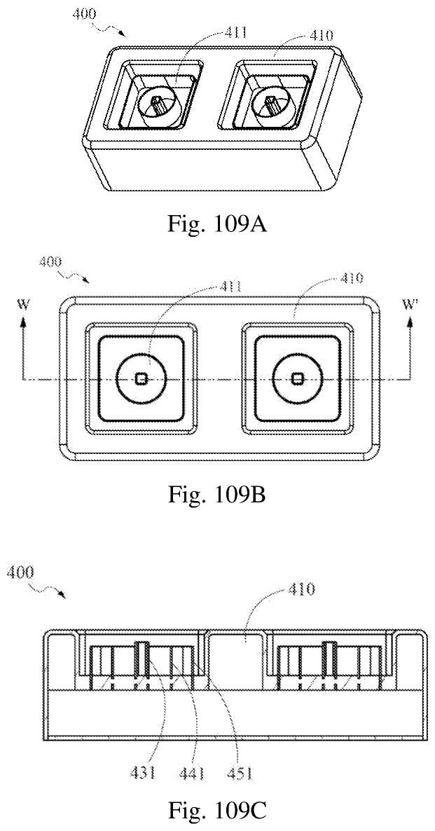

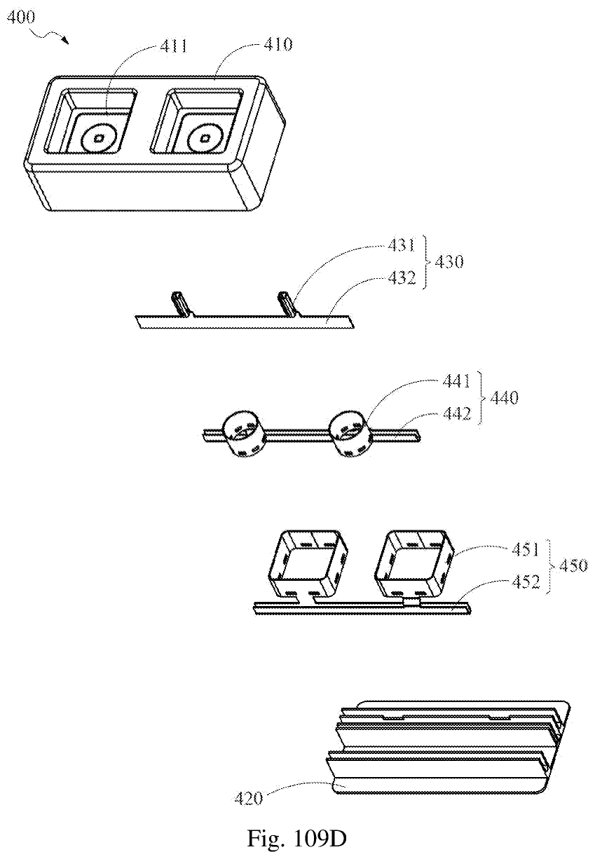

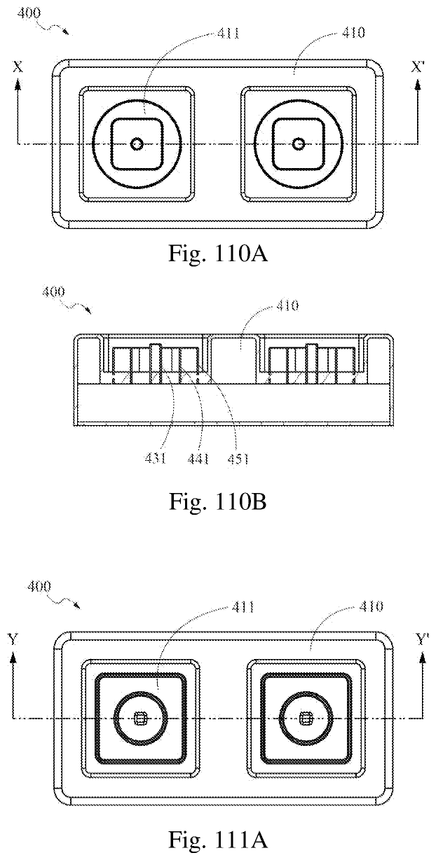

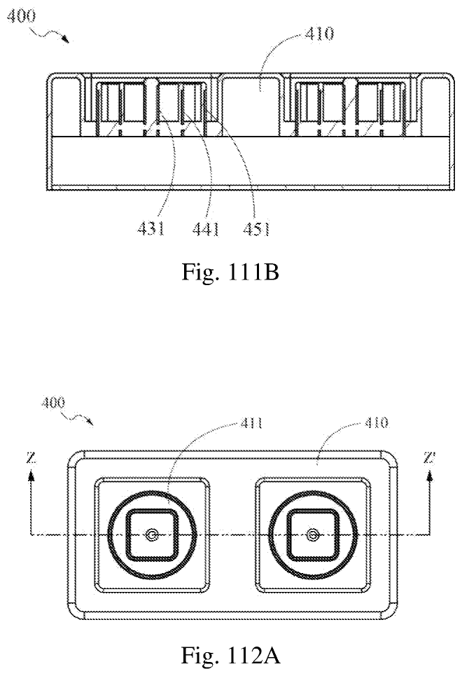

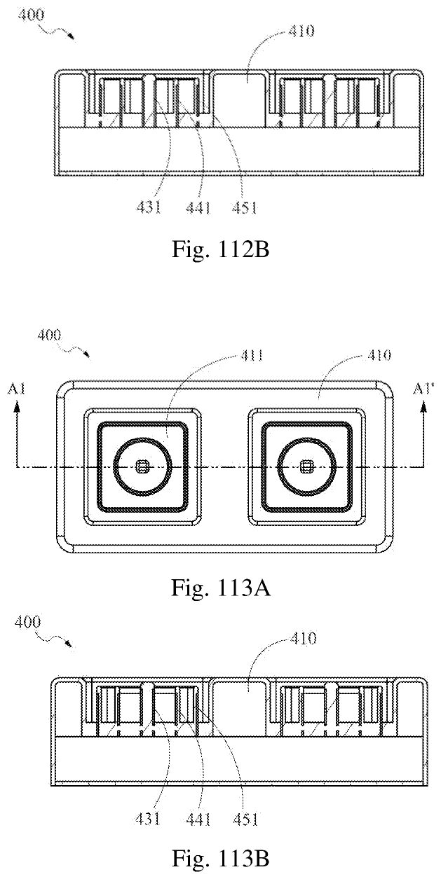

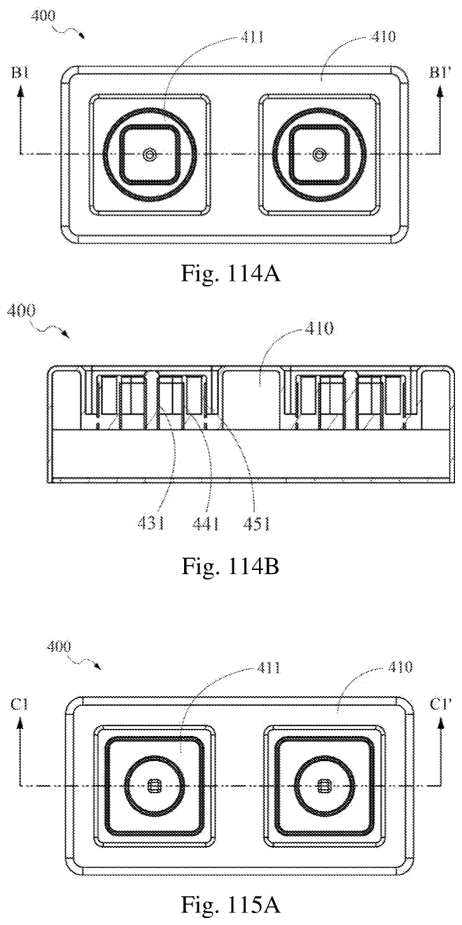

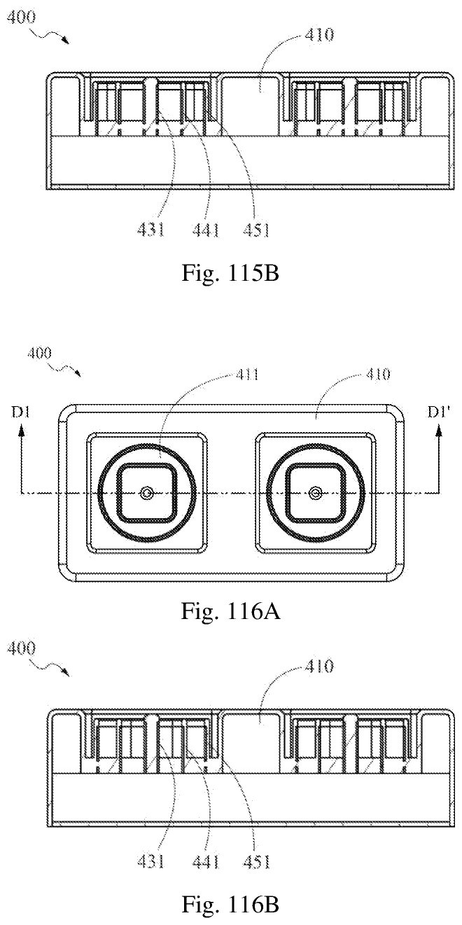

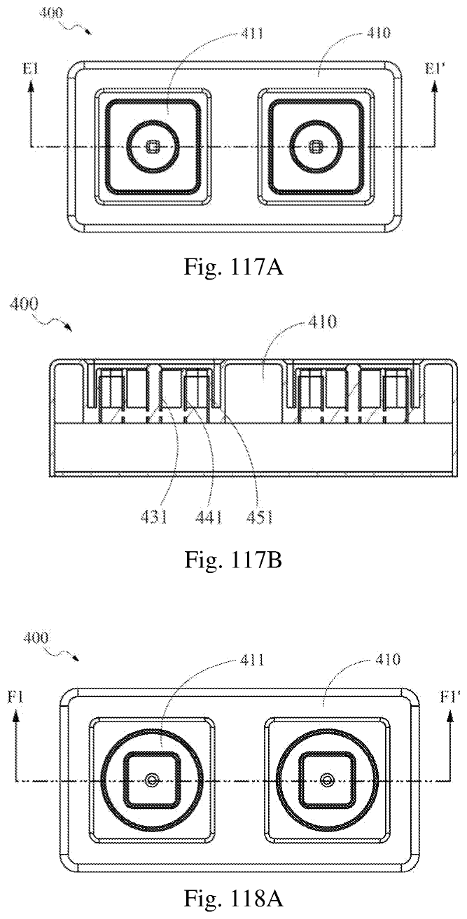

Please refers to FIGS. 97A-118. Different from the shape of the electrical connector, the base and the electrical connector assembly disclosed in the embodiments of FIGS. 1-56 is circular, the shapes of the electrical connector, the base and the electrical connector assembly disclosed in the embodiments of FIGS. 97A-118 are a combination of a square or a circle but the other structures are basically similar.

To sum up, embodiments of the present disclosure are directed to the electrical connector assembly and its base. The structural design of the contact interface does not have a specific assembling direction, so that the non-directional docking can be realized, and the assembly can be easily performed without restricting the circuit layout. Furthermore, it could save materials for the foolproof mechanism, and thus reduce the production cost.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. An electrical connector, comprising:
an upper insulating housing, having a first socket, a second socket and a third socket;
a lower insulating housing, connected with the upper insulating housing;
a first-polarity conductive terminal, having a first elastic piece portion and a first connection portion, wherein the first elastic piece portion is correspondingly arranged with a first socket of the upper insulating housing;
a second-polarity conductive terminal, having a second elastic piece portion and a second connecting portion, wherein the second elastic piece portion is arranged corresponding to a second socket of the upper insulating housing;
a central conductor, electrically connected to the first connecting portion of the first polarity conductive terminal, having a central fixing portion and a central contact portion, wherein the central fixing portion allows the central conductor to be fixed on the lower insulating housing;
an inner conductor, electrically connected to the second connection portion of the second polarity conductive terminal, having an inner fixing portion and an inner contact portion, wherein the inner fixing portion allows the inner conductor to be fixed on the lower insulating housing; and
a third-polarity conductive terminal, having a third elastic piece portion and a third connecting portion, wherein the third elastic piece portion is correspondingly arranged with a third inserting socket of the upper insulating housing; and
an outer conductor, electrically connected to the third connection portion of the third-polarity conductive terminal, having an outer fixing portion and an outer contact portion, wherein the outer fixing portion allows the outer conductor to be fixed on the lower insulating housing;
wherein the central contact portion of the central conductor, the inner contact portion of the inner conductor and the outer contact portion of the outer conductor are sequentially arranged outside the lower insulating housing from inside to outside.

2. The electrical connector of claim 1, wherein the lower insulating housing further comprises an extension portion, arranged on an outer side of the outer contact portion of the outer conductor.

3. The electrical connector of claim 1, wherein the lower insulating housing further comprises an extension portion, disposed between the central contact portion of the central conductor and the inner contact portion of the inner conductor, or between the inner contact portion of the inner conductor and the outer contact portion of the outer conductor.

4. The electrical connector of claim 1, wherein a center of the center contact portion, a center of the inner contact portion and/or a center of the outer contact portion coincide with each other.

5. A base, comprising:
a first insulating housing, having a first socket, a second socket, and a third socket;
a second insulating housing, connected with the first insulating housing;
a first conductor, having a first contact portion and a first fixing portion, wherein the first contact portion is arranged correspondingly to the first socket of the first insulating housing, and the first fixing portion allows the first conductor to be fixed between the first insulating housing and the second insulating housing;
a second conductor, having a second contact portion and a second fixing portion, the second contact portion is arranged corresponding to the second socket of the first insulating housing, and the second fixing portion allows the second conductor to be fixed between the first insulating housing and the second insulating housing; and
a third conductor, having a third contact portion and a third fixing portion, the third contact portion is arranged correspondingly to the third socket of the first insulating housing, and the third fixing portion allows the third conductor to be fixed between the first insulating housing and the second insulating housing;
wherein the first contact portion of the first conductor, the second contact portion of the second conductor, and the third contact portion of the third conductor are sequentially disposed outside the first insulating housing from inside to outside.

6. The base of claim 5, further comprising a spacer disposed between the first conductor and the second conductor.

7. An electrical connector, comprising:
an upper insulating housing, having at least one socket;
a lower insulating housing, having at least one slot, arranged under the upper insulating housing and connected with the upper insulating housing; and
a central conductor, having a central elastic piece portion, a central fixing portion and a central docking portion, wherein the central elastic piece portion is arranged correspondingly to one socket of the upper insulating housing, the central fixing portion allows the central conductor to be fixed between the upper insulating housing and the lower insulating housing, and the central docking portion is arranged correspondingly to one slot of the lower insulating housing;
an inner conductor, having an inner elastic piece portion, an inner fixing portion and an inner docking portion, wherein the inner elastic piece portion is arranged correspondingly to one socket of the upper insulating housing, the inner fixing portion allows the inner conductor to be fixed between the upper insulating housing and the lower insulating housing, and the inner docking portion is arranged correspondingly to one slot of the lower insulating housing; and/or
an outer conductor, having an outer elastic piece portion, an outer fixing portion and an outer docking portion, wherein the outer elastic piece portion is arranged correspondingly to a socket of the upper insulating housing, and the outer fixing portion allows the outer conductor to be fixed between the upper insulating housing and the lower insulating housing, and the outer docking portion is arranged correspondingly to a slot of the lower insulating housing;
wherein the central docking portion of the central conductor, the inner docking portion of the inner conductor and the outer docking portion of the outer conductor are sequentially disposed outside the lower insulating housing from inside to outside;
wherein the lower insulating housing comprises a first protruding portion and a second protruding portion, the first protruding portion is disposed between the central docking portion of the central conductor and the inner docking portion of the inner conductor to form a center docking slot, and the second protruding portion is disposed between the inner docking portion of the inner conductor and the outer docking portion of the outer conductor to form an inner docking slot.

8. The electrical connector of claim 7, wherein the lower insulating housing further comprises a third protruding portion, and the third protruding portion is disposed outside the external docking portion of the outer conductor to form an external docking slot.

9. The electrical connector of claim 7, wherein the lower insulating housing further comprises an inner accommodating groove, and the inner accommodating groove is arranged on the first protruding portion.

10. The electrical connector of claim 7, wherein the lower insulating housing further comprises an outer accommodating groove, and the outer accommodating groove is arranged on the second protruding portion.

11. The electrical connector of claim 7, wherein a center of the center contact portion, a center of the inner contact portion and/or the center of the outer contact portion coincide with each other.

12. A base, comprising:
a third insulating housing, having a first socket, a second socket and/or a third socket;
a fourth insulating housing, connected with the third insulating housing;
a first conductor, having a first contact portion and a first fixing portion, wherein the first contact portion is arranged correspondingly to the first socket of the third insulating housing, and the first fixing portion allows the first conductor to be fixed between the third insulating housing and the fourth insulating housing;
a second conductor, having a second contact portion and a second fixing portion, the second contact portion is arranged corresponding to the second socket of the third insulating housing, and the second fixing portion allows the second conductor to be fixed between the third insulating housing and the fourth insulating housing; and/or
a third conductor, having a third contact portion and a third fixing portion, the third contact portion is arranged correspondingly to the third socket of the third insulating housing, and the third fixing portion allows the third conductor to be fixed between the third insulating housing and the fourth insulating housing;
wherein the first contact portion of the first conductor, the second contact portion of the second conductor, and the third contact portion of the third conductor are sequentially disposed outside the third insulating housing from inside to outside.

13. The base of claim 12, further comprising a protection cover, wherein the protection cover is disposed on a front edge of the first contact portion of the first conductor, a front edge of the second contact portion of the second conductor, or a front edge of the third contact portion of the third conductor.

14. The base of claim 12, wherein the third insulating housing comprises an extension portion, and the extension portion contacts the first contact portion of the first conductor, the second contact portion of the second conductor, or the third contact portion of the third conductor.

15. The base of claim 14, wherein the extension portion extends to a front edge of the first contact portion of the first conductor, a front edge of the second contact portion of the second conductor, or a front edge of the third contact portion of the third conductor.

16. The base of claim 12, wherein the third insulating housing comprises an extension portion, and the extension portion is disposed between the first contact portion of the first conductor and the third contact portion of the third conductor.

17. The base of claim 16, wherein the extension portion extends to a front edge of the first contact portion of the first conductor, a front edge of the second contact portion of the second conductor, or a front edge of the third contact portion of the third conductor.
